(19) United States
(12) Patent Application Publication
(10) Pub. No.: US 2021/0261803 A1
(43) Pub. Date: Aug. 26, 2021

(54) PIGMENT DISPERSION COMPOSITION, CURABLE COMPOSITION, ACCOMMODATING CONTAINER, DEVICE FOR FORMING TWO OR THREE DIMENSIONAL IMAGES, METHOD OF FORMING TWO-DIMENSIONAL OR THREE-DIMENSIONAL IMAGES, CURED MATTER, AND DECORATION

(71) Applicant: RICOH COMPANY, LTD., Tokyo (JP)

(72) Inventors: Masahide KOBAYASHI, Kanagawa (JP); Mitsunobu MORITA, Shizuoka (JP); Takashi OKADA, Kanagawa (JP); Takenori SUENAGA, Tochigi (JP); Soh NOGUCHI, Kanagawa (JP); Tatsuki YAMAGUCHI, Kanagawa (JP)

(21) Appl. No.: 17/179,678

(22) Filed: Feb. 19, 2021

(30) Foreign Application Priority Data
Feb. 20, 2020 (JP) 2020-027138

(51) Int. Cl. C09D 11/322; C09D 11/101; C09D 11/037; C09D 11/38; C08F 20/28; B33Y 10/00; B33Y 70/00; B33Y 30/00; B33Y 80/00

(52) U.S. Cl. CPC C09D 11/322; C09D 11/101; C09D 11/037; C09D 11/38; B33Y 80/00; B33Y 10/00; B33Y 70/00; B33Y 30/00; C08F 20/28

(57) ABSTRACT

A pigment dispersion composition contains one or more pigments selected from the group consisting of strontium titanate, calcium titanate, and zinc sulfide, a pigment dispersant having an amine value of from 10 to 100 mgKOH/g and a polymerizable compound.

### CROSS-REFERENCE TO RELATED APPLICATIONS

This patent application is based on and claims priority pursuant to 35 U.S.C. § 119 to Japanese Patent Application No. 2020-027138, filed on Feb. 20, 2020, in the Japan Patent Office, the entire disclosure of which is hereby incorporated by reference herein.

### BACKGROUND

### Technical Field

The present disclosure relates to a pigment dispersion composition, curable composition, accommodating container, device for forming two or three dimensional images, method of forming two-dimensional or three-dimensional images, cured matter, and decoration.

### Description of the Related Art

Curable compositions free of solvents do not produce volatile organic compounds (VOC), which is advantageous to protect the environment and print on a non-liquid absorbing printing medium because such curable compositions quickly dry thereon.

Most curable compositions contain pigments as coloring materials because the pigments have good durabilities and resistances. Such a pigment is required to be uniformly dispersed in a curable composition. As the dispersability of pigment deteriorates, curable compositions are not readily filtered or discharged, which causes nozzle clogging.

Devices for covering the pigment with a resin and devices for adding a dispersant are used to uniformly disperse a pigment in a pigment dispersion composition.

### SUMMARY

According to embodiments of the present disclosure, a pigment dispersion composition is provided which contains one or more pigments selected from the group consisting of strontium titanate, calcium titanate, and zinc sulfide, a pigment dispersant having an amine value of from 10 to 100 mgKOH/g and a polymerizable compound.

### BRIEF DESCRIPTION OF THE SEVERAL VIEWS OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic diagram illustrating an example of the device for forming two dimensional images according to an embodiment of the present disclosure;

FIG. 2 is a schematic diagram illustrating an example of the device for forming three dimensional images according to an embodiment of the present disclosure; and

FIGS. 3A, 3B, 3C, and 3D are schematic diagrams illustrating another example of the device for forming three dimensional images according to an embodiment of the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Moreover, image forming, recording, printing, modeling, etc., in the present disclosure represent the same meaning, unless otherwise specified.

Embodiments of the present invention are described in detail below with reference to accompanying drawing(s). In describing embodiments illustrated in the drawing(s), specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

Next, aspects of embodiments of the present disclosure are described.

Pigment Dispersion Composition

The pigment dispersion composition contains one or more pigments selected from the group consisting of strontium titanate, calcium titanate, and zinc sulfate, a pigment dispersant having an amine value of from 10 to 100 mgKOH/g, a polymerizable compound, and other optional components. Strontium titanate, calcium titanate, and zinc sulfate are referred to as white pigments for convenience because they are used as white pigments in most cases; it is however, unnecessary to use them as white pigments.

Pigment dispersion compositions are normally unstable during storage because pigment dispersants and polymerizable compounds contained therein have a large polarity difference, which destabilizes compatibility between the pigment and the polymerizable compounds and degrades wettability of the pigment. Using a pigment dispersion composition having a poor storage stability for inkjet ink degrades white concealing property, liquid permeability, discharging stability, and curability, which results in poor attachability of an ink film.

The present inventors have formulated a pigment dispersion composition containing one or more pigments selected from the group consisting of strontium titanate, calcium titanate, and zinc sulfide, a pigment dispersant having an amine value of from 10 to 100 mgKOH/g, and a polymerizable compound, which achieves a high level of storage stability due to steric repulsion by enhancing the compatibility between the pigment and the dispersant medium (polymerizable compound) owing to the attachment of the pigment dispersant to the surface of the pigment, which enhances the wettability to the pigment by the dispersion medium, thereby stabilizing the attachment to the pigment.

Pigment Dispersant

The pigment dispersant has an amine value of from 10 to 100 mgKOH/g and preferably from 30 to 85 mgKOH/g. A high level of the storage stability is achieved owing to steric repulsion because an amine value of from 10 to 100 mgKOH/g stabilizes the adsorption of the pigment dispersant to the white pigment. It is possible to prevent the polymerization reaction between the pigment dispersant and the polymerizable compound during storage for a long period of time or heating so that the viscosity change ratio is small and a high level of storage stability is achieved.

The method for measuring an amine value is not particularly limited. One way of measuring is: A total of 1 g of a pigment dispersant is dissolved in 100 mL of methylisobutyl ketone; the solution is subjected to potentiometric titration with methylisobutyl ketone of chloric acid solution at 0.01 mol/L using an automatic titrator (GT-200, manufactured by Mitsubishi Chemical Analytech Co., Ltd.) to measure the potential; and the amine value is calculated on a basis of the obtained potential.

Pigment dispersant polymers are preferable as the pigment dispersant because the adsorption of the pigment dispersant to the pigment is stabilized, thereby achieving a high level of storage stability owing to steric repulsion.

The pigment dispersant polymer is preferably at least one of a copolymer having a basic functional group, an acrylic block copolymer, and a copolymer having an alkylol ammonium salt and an acid radical. These can be used alone or in combination.

The copolymer having a basic functional group contains a basic functional group.

Specific examples of the basic functional group include, but are not limited to, an amino group, imino group, amide group, imide group, basic polar functional group such as a nitrogen-containing heterocyclic group. The copolymer having a basic functional group readily adsorbs to the surface of the pigment by having a basic functional groups, thereby achieving a high level of storage stability. The copolymer having a basic functional group preferably contains an amino group in terms of adsorption ability to the pigment, dispersibility in the polymerizable compound, and a power of reducing viscosity of the pigment dispersion composition.

Acrylic block copolymers have multiple (meth)acrylic polymers prepared by polymerizing (meth)acrylic monomers as segments. An example of the acrylic block copolymer in a block copolymer having a hydrophobic block and a hydrophilic block. A dispersant polymer having a hydrophilic block and a hydrophobic block orientates the hydrophilic block to the surface of a pigment and spreads the hydrophobic block to the side of the dispersion medium so that a high level of storage stability is achieved by this steric repulsion. The surface activeness of the pigment covered with an acrylic block is low, thereby enhancing the dispersion ability into the dispersion medium so that a high level of dispersibility is achieved.

An example of the copolymer having an alkylol ammonium salt and an acid radical is a random copolymer or a block copolymer having a structural unit derived from (meth)acryloyl alkylol ammonium salt and a structural unit having an acid radical derived from (meth)acrylic acid.

The dispersant polymer is suitably synthesized and can be procured.

Specific examples of the procurable copolymers having a basic functional group include, but are not limited to, Solsperse Series (manufactured by Lubrizol Japan Ltd.) including Solsperse 20000 (amine value of 35.9 mgKOH/g), Solsperse 24000 (amine value of 41.6 mgKOH/g), Solsperse 32000 (amine value of 31.2 mgKOH/g), Solsperse 33000 (amine value of 43.0 mgKOH/g), Solsperse 35000 (amine value of 32.0 mgKOH/g), Solsperse 56000 (amine value of 39.0 mgKOH/g), Solsperse 71000 (amine value of 75.0 mgKOH/g), Solsperse 73000 (amine value of 80.0 mgKOH/g), Solsperse 74000 (amine value of 81.0 mgKOH/g), and Solsperse 88000 (amine value of 33.0 mgKOH/g), and Solsperse J200 (amine value of 18.6 mgKOH/g), DisperBYK-162 (amine value of 13 mgKOH/g), DisperBYK-163 (amine value of 10 mgKOH/g), and DisperBYK-168 (amine value of 11 mgKOH/g). These can be used alone or in combination.

Specific examples of the procurable acrylic block copolymers include, but are not limited to, DTSPERBYK Series (manufactured by BYK Japan KK.) including DTSPERBYK-2050 (amine value of 30.7 mgKOH/g), DISPERBYK-2055 (amine value of 45.1 mgKOH/g), DISPERBYK-2150 (amine value of 56.7 mgKOH/g), and DISPERBYK-2155 (amine value of 52.5 mgKOH/g). These can be used alone or in combination.

Specific examples of the procurable copolymer having an alkylol ammonium salt and an acid radical include, but are not limited to, DISPERBYK-140 (amine value of 76.0 mgKOH/g) and DISPERBYK-180 (amine value of 94.0 mgKOH/g). These can be used alone or in combination.

The weight average molecular weight of the dispersant polymer is preferably from 1,000 or more and more preferably from 1,000 to 10,000. The weight average molecular weight can be measured by, for example, gel permeation chromatography (GPC).

The proportion of the pigment dispersant in the total mass of the pigment dispersion composition is preferably from 2.0 to 12.0 percent by mass and more preferably from 2.0 to 7.5 percent by mass to achieve storage stability.

The proportion of the pigment dispersant to the total mass of the pigment is preferably from 10.0 to 70.0 percent by mass to enhance storage stability.

The ratio (B to A) of the content (B) of the pigment dispersant to the content (A) of the white pigment is preferably from 0.10 to 0.80 and more preferably from 0.10 to 0.50. A ratio (B to A) of 0.10 or more achieves a high level of storage stability owing to the steric repulsion of the pigment dispersant adsorbed to the white pigment. A ratio (B to A) of 0.80 or less reduces the viscosity of the pigment dispersion composition, thereby achieving a high level of storage stability because the amount of the pigment dispersant not adsorbed to the white pigment is small.

It is preferable that the proportion of the pigment dispersant not adsorbed to a white pigment to the pigment dispersant adsorbed to a white pigment be from 15 to 50 percent by mass. When the proportion of the pigment dispersant not adsorbed to a white pigment is 15 percent by mass or more, the pigment dispersant adsorbed to a white pigment is transferred to the dispersion medium (polymerizable compound), thereby achieving a high level of storage stability. A proportion of the pigment dispersant not adsorbed to a white pigment of 50 percent by mass or less achieves a high level of storage stability.

The proportion of the pigment dispersant adsorbed to a white pigment is not particularly limited. The attributes such as the amount, acid value, and amine value of the pigment dispersant have an impact on the proportion. It can be suitably selected depending on the particle diameter, surface treated state, dispersion condition of the pigments.

The amount of the pigment dispersant adsorbed to a pigment is obtained in the following manner.

A target composition at 1 mL is loaded into a tube for centrifugal to separate it into a sediment solid component and supernatant liquid using a centrifugal (desktop high speed centrifuge CT13 type, manufactured by Hitachi Koki Co., Ltd.) at 13,000 rotation per minute (rpm) for 90 minutes. After removing supernatant, a total of 1 mL of acetone is added followed by loosening the sediment solid component with a spatula. The resulting material is subjected to ultrasonic wave dispersion for 20 minutes.

The resulting material is subjected to a rinsing process including centrifuge and rinsing with acetone four times to obtain a sediment solid composition after the supernatant is removed. The number of repeating the rinsing process is determined after the amount of non-volatile portion of the supernatant liquid is identified. The obtained sediment solid component is completely purged of acetone at 25 degrees C. under a reduced pressure to obtain a pigment to which the pigment adsorption component such as the polymer dispersant is adsorbed. The obtained pigment at 100 mg is baked in an electrical furnace (ROP-001, manufactured by AS ONE Corporation.) at 400 degrees C. for 60 minutes. The loss of weight as a result of baking the pigment is measurable as the amount of pigment adsorption component.

The amount of the pigment dispersant not adsorbed to the pigment can be measured by purging the supernatant of acetone.

Polymerizable Compound

The polymerizable compound has a polymerizable functional group and can be polymerized upon application of heat or active energy radiation such as ultraviolet and electron beams. The polymerizable compound used can be suitably selected to suit to a particular application depending on reaction speed, properties of compounds, and properties of cured film.

Polymerizable Compound Having SP Value of 9.00 or Greater

The polymerizable compound preferably has a solution parameter (SP value) of 9.00 or greater and particularly preferably 10.00 or greater. Since an SP value of 9.00 or greater decreases the polarity difference (the SP value difference) between the polymerizable compound and the pigment dispersant and stabilizes the adsorption of the pigment dispersant to the white pigment, a high level of storage stability is achieved by steric repulsion. Dispersibility of the white pigment is enhanced, which makes the particle size distribution uniform; the number of excessively small particles and agglomerated particles decreases.

Solubility parameter is also referred to as SP value and calculated according to the following Small formulation (1).

σ=ρ·(ΣFi)/M (1)

In (1), a represents SP value, ρ represents density, Fi represents the mol suction force constant, and M represents the molecular weight of the repeating unit (monomer) of a polymer.

Specific examples of the polymerizable compounds with an SP value of 9.00 or greater include, but are not limited to, tetrahydrofluryl acrylate (SP value: 9.97), phenoxiethyl acrylate (SP value: 9.99), acryloilmorpholine (SP value: 11.55), methacryloyl morpholine, hydroxyethyl acrylamide (SP value: 15.63), hydroxyethymethacryl amide, N-vinylformamide (SP value: 11.01), 4-hydroxybutyl acrylate (SP value: 11.31), 4-hydroxybutyl methacrylate, phenoxydiethylene glycol acrylate (SP value: 10.01), phenoxidiethylglycol methacrylate, methoxitetraethylene glycol acrylate (SP value: 10.15), methoxitetraethylethyle glycol methacrylate, pentaerythritol triacrylate (SP value: 10.25), pentaerylthritol trimethacrylate, dicyclopentanil dimethylene diacrylate (SP value: 10.34), dicyclopentanil dimethylene dimethacrylate, dicyclopentanil oxyacrylate (SP value: 10.35), dicyclopentanyl oxymethacrylate, dicyclopentenyl oxyethyl acrylate (SP value: 10.44), dicyclopentenyl oxyethyl methacrylate, cyclohexyl acrylate (SP value: 10.54), cyclohexyl methacrylate, N-vinyl caprolactam (SP value: 10.65), and compounds (SP value: 11.58) represented by the following Chemical Formula (1). Of these compounds, phenoxyethyl acrylate, acryloilmorpholine, hydroxybutyl acrylate, tetrahydrofluryl acrylate, methoxitetraethylene glycol acrylate, dicyclopentanyl oxyethyl acrylate, and the compound represented by the following Chemical Formula (1) are preferable. These can be used alone or in combination.

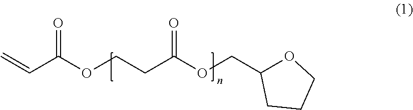

In (1), n represents an integer of 1 or above.

The proportion of the polymerizable compound having an SP Value of 9.00 or greater in the pigment dispersion composition is preferably from 10 to 95 percent by mass, more preferably from 15 to 90 percent by mass, and particularly preferably from 20 to 85 percent by mass. The pigment dispersion composition may contain a polymerizable compound having an SP Value below 9.00. The proportion of the polymerizable compound having an SP value below 9.00 in the total of the pigment dispersion composition is preferably 10 percent by mass or below.

Other Polymerizable Compound

The polymerizable compound is not limited to the polymerizable compound mentioned above and includes known polymerizable compounds. Examples of such known polymerizable compounds include, but are not limited to, radically polymerizable compounds and polymerizable oligomers.

Specific examples of the radically polymerizable monomer include, but are not limited to, (meth)acrylates, (meth)acrylicamides, and aromatic vinyls. These can be used alone or in combination. (Meth)acrylate means at least one of acrylate and methacrylate and (meta)acrylic means at least one of the acrylic and methacrylic.

(Meth)acrylate

Examples of the (meth)acrylates include, but are not limited to, mono-functional (meth)acrylates, bi-functional (meth)acrylates, tri-functional (meth)acrylates, tetrafunctional (meth)acrylates, pentafunctional (meth)acrylates, and hexafunctional (meth)acrylates. These can be used alone or in combination.

The monofucntional (meta)acrylates include, but are not limited to, hexyl(meta)acrylate, 2-ethylhexyl(meta)acrylate, tert-octyl (meta)acrylate, isoamyl(meta)acrylate, decyl(meta)acrylate, isodecyl(meta)acrylate, stearyl(meta)acrylate, isostearyl (meth)acrylate, cyclohexyl(meta)acrylate, 4-n-butylcyclohexyl(meta)acrylate, b oronyl(meta)acrylate, isoboronyl(meta)acrylate, benzyl(meta)acrylate, butoxyethyl (meta)acrylate, 2-chloroethyl (meta)acrylate, 4-bromobutyl(meta)acrylate, cyanoethyl(meta)acrylate, benzyl(meta)acrylate, butoxymethyl(meta)acrylate, 3-methoxybutyl(meta)acrylate, alkoxymethyl(meta)acrylate, alkoxyethyl(meta)acrylate, 2-(2-methoxyethoxy)ethyl(meth)acrylate, 2-(2-butoxyethoxy)ethyl(meth)acrylate, 2,2,2-tetrafluoroethyl (meta)acrylate, 1H, 1H, 2H, 2H-perfluorodecyl (meta)acrylate, 4-butylphenyl(meta)acrylate, phenyl(meta)acrylate, 2,4,5-tetramethylphenyl(meta)acrylate, 4-chlorophenyl(meta)acrylate, phenoxymethyl(meta)acrylate, phenoxyethyl(meta)acrylate, glycidyl(meta)acrylate, glycidyloxydibutyl(meth)acrylate, glycidyloxyethyl(meth)acrylate, glycidyloxypropyl(meta)acrylate, tetrahydro furfuryl(meta)acrylate, hydroxyalkyl(meta)acrylate, 2-hydroxyethyl(meta)acrylate, 3-hydroxypropyl(meta)acrylate, 2-hydroxypopyl(meta)acrylate, 2-hydroxybutyl(meth)acrylate, 4-hydroxybutyl(meth)acrylate, dimethylaminoethyl(meta)acrylate, diethyl aminoethyl(meta)acrylate, dimethylaminopropyl(meta)acrylate, diethyl aminopropyl(meta)acrylate, trim ethoxysilylpropyl(m eta)acrylate, trimethylsilyl propyl(meta)acrylate, polyethylene oxide monomethylether(meta)acrylate, oligoethylene oxide monomethylether(meta)acrylate, polyethylene oxide(meta)acrylate, oligoethylene oxide(meta)acrylate, oligoethylene oxide monoalkylether(meta)acrylate, polyethylene oxide monalkylether(meta)acrylate, dipropylene glycol(meta)acrylate, polypropylene oxide monoalkylether(meth)acrylate, oligopropylene oxide monoalkylether(m eth)acrylate, 2-methacryloyloxy methyl succinate, 2-methacryloxy hexahydrophthalate, 2-methacryloyloxyethyl-2-hydroxypropyl phthalate, butoxy diethyleneglycol(meta)acrylate, triflioroethyl(meta)acrylate, perfluorooctyl ethyl(meth)acrylate, 2-hydroxy-3-phenoxypropyl(meth)acrylate, ethylene oxide-modified phenol(meta)acrylate, ethylene oxide-modified crezole(meta)acrylate, ethylene oxide-modified nonylphenol (meta)acrylate, propylene oxide-modified nonyl phenol(meta)acrylate, ethylene oxide-modified-2-ethylhexyl (meta)acrylate, acrylic acid-2-(2-vinyloxyethoxy)ethyl, and benzyl acrylate. These can be used alone or in combination. Of these acrylates, phenoxyethyl(meta)acrylate, benzyl acrylate, acrylic acid-2-(2-viniloxyethoxy)ethyl, 2-hydroxy ethyl(meta)acrylate, 3-hydroxypropyl(meta)acrylate, 2-hydroxypropyl(meth)acrylate, and 4-hydroxybutyl (meth)acrylate are preferable to achieve low viscosity, low level of odor, and good curability. Phenoxyethyl(meta)acrylate, benzylacrylate, and acrylic acid-2-(2-vinyloxyethoxy)ethyl are particularly preferable to be compatible with a photopolymerization initiators and other monomers.

Specific examples of the bifunctional (meth)acrylates include, but are not limited to, 1,6-hexanediol di(meth)acrylate, 1,10-decanediol di(meth)acrylate, neopentylglycol di(meth)acrylate, 2,4-dimethyl-1,5-pentane diol di(meth)acrylate, butylethylpropane diol di(meth)acrylate, ethoxylated cyclohexanemethanol di(meth)acrylate, polyethylene glycol di(meth)acrylate, oligoethylene glycol di(meth)acrylate, ethylene glycol di(meth)acrylate, 2-ethyl-2-butyl-butanediol di(meth)acrylate, hydroxy pivalic acid neopentylglycol di(meth)acrylate, Ethylene oxide-modified bisphenol A di(meth)acrylate, bisphenol F polyethoxy di(meth)acrylate, polypropylene glycol di(meth)acrylate, oligopropylene glycol di(meth)acrylate, 1,4-butanediol di(meth)acrylate, 2-ethyl-2-butyl propanediol di(meth)acrylate, 1,9-nonane di(meth)acrylate, propoxylated ethoxylated bisphenol A di(meth)acrylate, and tricyclodecane di(meth)acrylate. These can be used alone or in combination.

Specific examples of the trifunctional (meta)acrylates include, but are not limited to, alkylene oxide-modified tri(meta)acrylate of trimethyrol propane tri(meta)acrylate, trimethylolethane tri(meta)acrylate, and trimethylolpropane, pentaerythritol tri(meta)acrylate, dipentaerythritol tri(meta)acrylate, trimethylol propane tri(meta)acryloyloxy propyl)ether, alkylene oxide-modified tri(meta)acrylate isocyanurate, dipentaerythritol tri(meta)acrylate propionate, tri(meth)acryloyloxyethyl isocyanulate, hydroxy pivalaldehyde-modified dimethylol propane tri(meth)acrylate, sorbitol tri(meth)acrylate, propoxylated trimethylol propane tri(meta)acrylate, and ethoxylated glycerin tri(meta)acrylate. These can be used alone or in combination.

Specific examples of the tetrafunctional (meth)acrylates include, but are not limited to, pentaerythritol tetra(meth)acrylate, sorbitol tetra(meth)acrylate, ditrimethylol propanetetra(meth)acrylate, dipentaerythritol tetra(meth)acrylate propionate, and ethoxylated pentaerythritol tetra(meth)acrylate. These can be used alone or in combination.

Specific examples of the pentafunctional (meth)acrylate include, but are not limited to, sorbitol penta(meth)acrylate and dipentaerythritol penta(meth)acrylate. These can be used alone or in combination.

Specific examples of the hexafunctional (meth)acrylates include, but are not limited to, dipentaerythritol hexa(meth)acrylate, sorbitol hexa(meth)acrylate, alkyleneoxide-modified hexa(meth)acrylate of phosphazene, and caprolactone-modified dipentaerythritol hexa(meth)acrylate. These can be used alone or in combination.

(Meth)acrylic Amide

Specific examples of (meta)acrylamide compounds include, but are not limited to, (meta)acrylamide, N-methyl (meta)acrylamide, N-ethyl (meta)acrylamide, N-propyl (meta)acrylamide, N-n-butyl (meta)acrylamide, N-t-butyl (meta)acrylamide, N-butoxymethyl (meta)acrylamide, N-isopropyl (meth)acrylamide, N-methylol (meth) acrylamide, N, N-dimethyl (meta)acrylamide, N,N-diethyl (meta)acrylamide, (meta)acryloyl morpholine, and hydroxyethyl (meta)acrylamide. These can be used alone or in combination. Of these (meth)acrylamides, (meth)acryloyl morpholine is preferable.

Aromatic Vinyl Compound

Specific examples include, but are not limited to, styrene, methyl styrene, dimethyl styrene, trimethyl styrene, ethyl styrene, isopropyl styrene, chloromethyl styrene, methoxy styrene, acetoxy styrene, chloro styrene, dichloro styrene, bromo styrene, vinyl benzoate methylester, 3-methyl styrene, 4-methyl styrene, 3-ethyl styrene, 4-ethyl styrene, 3-propyl styrene, 4-propyl styrene, 3-butyl styrene, 4-butyl styrene, 3-hexyl styrene, 4-hexyl styrene, 3-octyl styrene, 4-octyl styrene, 3-(2-ethylhexyl) styrene, 4-(2-ethylhexyl) styrene, allyl styrene, isopropenyl styrene, butenyl styrene, octenyl styrene, 4-t-butoxy carbonyl styrene, 4-methoxy styrene, and 4-t-butoxy styrene. These can be used alone or in combination.

Polymerizable Oligomer

The polymerizable oligomer preferably has one or more ethylenyl unsaturated double bonds. Oligomer means a polymer having 2 to 20 repeating monomer structural units. The weight average molecular weight of the polymerizable oligomer has no particular limit and can be suitably selected to suit to a particular application. It is preferably from 1,000 to 30,000 and preferably from 5,000 to 20,000 in polystyrene conversion. The weight average molecular weight can be measured by gel permeation chromatography (GPC).

Specific examples of the polymerizable oligomer include, but are not limited to, urethaneacrylic oligomers such as aromatic urethane acrylic oligomer and aliphatic urethane acrylic oligomer, epoxy acrylate oligomer, polyester acrylate oligomer, and other special oligomers. These can be used alone or in combination. Of these oligomers, oligomers having 2 to 5 unsaturated carbon-carbon bond are preferable and oligomers having 2 unsaturated carbon-carbon bond are more preferable. Oligomers having 2 to 5 unsaturated carbon-carbon bond have good curability.

The polymerizable oligomer can be suitably synthesized or procured.

Specific examples of procurable polymerizable oligomer include, but are not limited to, UV-2000B, UV-2750B, UV-3000B, UV-3010B, UV-3200B, and UV-3300B, UV-3700B, UV-6640B, UV-8630B, UV-7000B, UV-7610B, UV-1700B, UV-7630B, UV-6300B, UV-6640B, UV-7550B, UV-7600B, UV-7605B, UV-7610B, UV-7630B, UV-7640B, UV-7650B, UT-5449, and UT-5454 (all manufactured by The Nippon Synthetic Chemical Industry Co., Ltd.), CN902, CN902J75, CN929, CN940, CN944, CN944B85, CN959, CN961E75, CN961H81, CN962, CN963, CN963A80, CN963B80, CN963E75, CN963E80, CN963J85, CN964, CN965, CN965A80, CN966, CN966A80, CN966B85, CN966H90, CN966J75, CN968, CN969, CN970, CN970A60, CN970E60, CN971, CN971A80, CN971J75, CN972, CN973, CN973A80, CN973H85, CN973J75, CN975, CN977, CN977C70, CN978, CN980, CN981, CN981A75, CN981B88, CN982, CN982A75, CN982B88, CN982E75, CN983, CN984, CN985, CN985B88, CN986, CN989, CN991, CN992, CN994, CN996, CN997, CN999, CN9001, CN9002, CN9004, CN9005, CN9006, CN9007, CN9008, CN9009, CN9010, CN9011, CN9013, CN9018, CN9019, CN9024, CN9025, CN9026, CN9028, CN9029, CN9030, CN9060, CN9165, CN9167, CN9178, CN9290, CN9782, CN9783, CN9788, and CN9893 (all manufactured by Sartomer Company), EBECRYL210, EBECRYL220, EBECRYL230, EBECRYL270, KRM8200, EBECRYL5129, EBECRYL8210, EBECRYL8301, EBECRYL8804, EBECRYL8807, EBECRYL9260, KRM7735, KRM8296, KRM8452, EBECRYL4858, EBECRYL8402, EBECRYL9270, EBECRYL8311, and EBECRYL8701 (all manufactured by Daicel Cytec).

These can be used alone or in combination.

Pigment

The pigment is any member selected from the group consisting of strontium titanate, calcium titanate, and zinc sulfide. The pigment preferably has a number average primary particle diameter of from 30 to 350 nm and more preferably 100 to 300 nm. A number average primary particle diameter of from 100 to 300 nm can enhance dispersibility. The number average primary particle diameter is defined as the average of the cumulative distribution obtained by measuring the diameters in a certain direction of 200 to 500 primary particles sandwiched between two parallel lines drawn along a certain direction with a scanning electron microscope (SU3500, manufactured by Hitachi High-Technologies Corporation) in a 10,000× magnification field.

It is preferable to subject the pigment to the surface treatment such as acidic treatment to achieve good dispersibility. The basic dispersant polymer is readily adsorbed due to acidic treatment, thereby enhancing dispersibility owing to steric repulsion.

The surface treatment is not particularly limited and can be suitably selected to suit to a particular application. The pigment can be treated with pigment derivative treatment, resin modification, oxidization treatment, and plasma treatment.

The pigment is not particularly limited and suitably selected to suit to a particular application. For example, inkjet pigments, pigments for cosmetic, and pigments for dental can be selected.

These pigments can be procured.

Specific examples include, but are not limited to, SW-100 (strontium titanate obtained by baking, number average primary particle diameter: 320 nm, manufactured by Titan Kogyo, Ltd.), SW-300 (strontium titanate obtained by wetting method, number average primary particle diameter: 320 nm, manufactured by Titan Kogyo, Ltd.), SW-350 (strontium titanate obtained by wetting method, number average primary particle diameter: 300 nm, manufactured by Titan Kogyo, Ltd.), TC-100 (calcium titanate, number average primary particle diameter: 250 nm, manufactured by Titan Kogyo, Ltd.), TC-110 (calcium titanate, number average primary particle diameter: 250 nm, manufactured by Titan Kogyo, Ltd.), SACHTORITH HD-S(number average primary particle diameter: 300 nm, manufactured by Connel Brothers Japan), XZ-100F (zinc oxide, number average primary particle diameter: 100 nm, manufactured by SAKAI CHEMICAL INDUSTRY CO., LTD.), XZ-300F (zinc oxide, number average primary particle diameter: 300 nm, manufactured by SAKAI CHEMICAL INDUSTRY CO., LTD.), XZ-100F-LP (zinc oxide, number average primary particle diameter: 100 nm, manufactured by SAKAI CHEMICAL INDUSTRY CO., LTD.), and XZ-300F-LP (zinc oxide, number average primary particle diameter: 300 nm, manufactured by SAKAI CHEMICAL INDUSTRY CO., LTD.). These can be used alone or in combination.

The proportion of the white pigment in the total mass of the pigment composition is preferably from 3 to 50 percent by mass. When the pigment composition is used as a curable composition, its proportion in the total mass of the curable composition is preferably from 1 to 10 percent by mass. A proportion of 1 percent by mass or more enhances coloring property and a proportion of 10 percent by mass of less prevents an increase of viscosity and enhances dischargeability.

Other Components

The other components are not particularly limited and can be suitably selected to suit to a particular application. Examples include, but are not limited to, polymerization inhibitors, slipping agents (surfactant), penetration-enhancing agents, wetting agents (humectants), fixing agents, fungicide, preservatives, antioxidants, ultraviolet absorbents, chelate agents, pH regulator, and thickeners.

The pigment dispersion composition may contain an organic solvent, but if possible, it is preferred that the composition be free of an organic solvent. The composition free of an organic solvent, in particular a volatile organic compound (VOC), is preferable because it enhances safeness at which the composition is handled so that the environment can be prevented from pollution. The “organic solvent” represents a non-reactive organic solvent such as ether, ketone, xylene, ethylacetate, cyclohexanone, or toluene, which is clearly distinguished from a reactive monomer. Furthermore, “free of” an organic solvent means that no organic solvent is substantially contained. The proportion thereof is preferably less than 0.1 percent by mass.

Viscosity

The viscosity of the pigment dispersion composition of the present disclosure has no particular limit and can be adjusted to suit to a particular application and device. For example, if a discharging device that discharges the composition from nozzles is used, the viscosity thereof is preferably in the range of from 3 to 40 mPa·s, more preferably from 5 to 15 mPa·s, and particularly preferably from 6 to 12 mPa·s in the temperature range of from 20 to 65 degrees C., preferably at 25 degrees C. It is preferable to satisfy this viscosity range without containing the organic solvent mentioned above.

Viscosity can be measured by a cone plate rotary viscometer (VISCOMETER TVE-22L, manufactured by TOKI SANGYO CO., LTD.) using a cone rotor (1° 34′×R24) at a rate of rotation of 50 rpm at a temperature of hemathermal circulating water in the range of 20 to 65 degrees C. VISCOMATE VM-150III can be used for the temperature control of the circulating water.

The pigment dispersion composition preferably has a viscosity change ratio of 15 percent or less, more preferably 10 percent or less, and particularly preferably 5 percent or less. A viscosity change ratio of 15 percent or less enhances the storage stability and dispersibility. The viscosity change ratio can be obtained from the following formula (2). Viscosity of the viscosity change ratio can be measured with a cone plate rotary viscometer (VISCOMETER TV-22, manufactured by TOKI SANGYO CO., LTD.) at a rate of rotation of 50 rpm, a temperature of hemathermal circulating water at 25 degrees C., and a shearing speed of 191.4 sec⁻¹.

Viscosity change ratio(percent)=(Viscosity after stored at 70 degrees C. for 14 days−initial viscosity)/(initial viscosity)×100 (2)

Manufacturing Method

The pigment dispersion composition can be manufactured by mixing a pigment, a pigment dispersant, and a polymerizable compound followed by dispersing with a dispersion device.

Specific examples of the dispersion device include, but are not limited to, a device using media such as a ball mill, sand mill, and a bead mill, and a media-free dispersion device. It is effective to conduct dispersion at a high concentration state about twice as much as the target pigment concentration of a dispersion and dilute with a dispersion medium (polymerizable compound) to the target pigment concentration before the dispersion is extracted. The proportion of the pigment to the dispersant polymer increases in a high pigment concentration. The number of contacts between the pigment and the dispersant polymer is expected to increase in such a state, which promotes adsorption of the dispersant polymer to the pigment.

It is preferable to use zirconia beads as the dispersion medium in a dispersion device using media to enhance dispersibility and dispersion efficiency. These dispersion methods can be used in combination. In the case of a ball mill dispersion, a two-step dispersion of dispersing with zirconia beads having a diameter of 5 mm followed by dispersion with zirconia beads having a diameter of 1 mm is possible to prepare a liquid dispersion having a uniform particle size distribution.

Media-free dispersion devices do not pulverize pigment particles because they do not provide excessive energy to the pigment. Instead, the adsorption of the dispersant polymer to the pigment surface is promoted so that storage stability is enhanced. In addition to the prevention of excessive dispersion, production of fine powder and coarse powder in the system can be minimized because contamination attributable to media does not occur.

Uniformity of the particle size distribution can be improved because of these enhancement and minimization; therefore, a high level of discharging stability can be achieved.

Examples of the media-free dispersion device are classified into dispersion devices utilizing high shearing forces on a basis of collision dispersion and ultrasonic wave dispersion and dispersion devices utilizing high speed stirring.

A specific example of the dispersion devices utilizing high speed shearing forces is a NanoVater™ series laboratory machine (C-ES008, manufactured by Yoshida Kikai Co., Ltd.).

The temperature of the liquid dispersion during dispersion is preferably from 5 to 60 degrees C. A temperature of from 5 to 60 degrees C. of the liquid dispersion can prevent curing reaction of the monomer. It is possible to add a small amount of a polymerization inhibitor beforehand to reduce curing reaction.

Application Field

The application field of the pigment dispersion composition is not particularly limited and can be suitably selected to suit to a particular application. It can be used for a curable composition, curable ink, curable inkjet ink, and paint. One way of using the pigment dispersion composition as a curable composition is described below.

Curable Composition

The pigment dispersion composition described above can be used as a curable composition (hereinafter, also referred to as curable ink). The curable composition is cured upon application of heat, active energy, and other forms of energy. The curable composition contains the pigment, pigment dispersant, polymerizable compound described above, and a polymerization initiator and preferably contains substances such as a polymerization inhibitor and surfactant.

The curable composition may be prepared by preparing a pigment dispersion composition first and then adding required components. The required components further include the polymerizable compound described above.

Polymerization Initiator

Examples of the polymerization initiator include, but are not limited to, thermal polymerization initiators and photopolymerization initiators. Of these, photopolymerization initiators are preferable.

The photopolymerization initiator produces active species such as a radical or a cation upon an application of energy of active energy and initiates polymerization of a polymerizable compound (monomer or oligomer). A known polymerization initiator including a radical polymerization initiator and a cationic polymerization initiator can be used alone or in combination as the polymerization initiator. Of these initiators, radical polymerization initiators are preferable. The proportion of the polymerization initiator in the total mass of the pigment dispersion composition is preferably from 5 to 20 percent by mass to achieve a sufficient curing speed.

Specific examples of the radical polymerization initiators include, but are not limited to, aromatic ketones, acylphosphineoxide compounds, aromatic oniumchlorides, organic peroxides, thio compounds (thioxanthone compounds, compounds including thiophenyl groups, etc.), hexaarylbiimidazole compounds, ketoxime-esterified compounds, borate compounds, azinium compounds, metallocene compounds, active ester compounds, compounds having a carbon halogen bond, and alkylamine compounds. These can be used alone or in combination.

A polymerization promoter can be optionally used together with the polymerization initiator.

The polymerization promoter is not particularly limited.

Specific examples include, but are not limited to, p-dimethylamino ethylbenzoate, p-dimethylamino-2-ethylhexylbenzoate, p-dimethyl amino methylbenzoate, 2-dimethylaminoethyl benzoate, and p-dimethyl butoxyethylaminobenzoate. These can be used alone or in combination.

The thermal polymerization initiator is not particularly limited and can be suitably selected to suit to a particular application.

Examples thereof include, but are not limited to, azo-based initiators, peroxide initiators, persulfate initiators, and redox (oxidation-reduction) initiators.

Polymerization Inhibitor

Specific examples of the polymerization inhibitor include, but are not limited to, p-methoxyphenol, 4-methoxy-1-naphthol, methylhydroquinone, hydroquinone, t-butylhydroquinone, di-t-butylhydroquinone, methoquinone, 2,2′-dihydroxy-3,3′-di(α-methylcyclohexyl)-5,5′-dimethyldiphenylmethane, p-benzoquinone, di-t-butyl diphenylamine, and 9,10-di-n-butoxycyan anthracene, 4,4′-[1,10-dioxo-1,10-decandiylbis(oxy)]bis[2,2,6,6-tetramethyl]-1-piperidinyloxy).

The proportion of the polymerization inhibitor to the total mass of the polymerization initiator is preferably from 0.005 to 3 percent by mass. A proportion of 0.005 percent by mass or more can enhance storage stability and minimize an increase of viscosity in a high temperature environment. A proportion of 3 percent by mass or less enhances curability.

Surfactant

The surfactant has no specific limit and can be suitably selected to suit to a particular application. Examples include, but are not limited to, higher aliphatic acid surfactants, silicone-based surfactants, and fluorochemical surfactants.

The proportion of the surfactant in the total mass of the pigment dispersion composition is preferably from 0.1 to 3 percent by mass and more preferably from 0.2 to 1 percent by mass. A proportion of 0.1 percent by mass or more can enhance wettability and a proportion of 3 percent by mass or less can enhance curability. The wettability and leveling of the surfactant can be enhanced within the more preferable range of the proportion.

### Organic Solvent

The curable composition may contain an organic solvent, but if possible, it is preferred that the composition be free of an organic solvent. The composition free of an organic solvent, in particular a volatile organic compound (VOC), is preferable because it enhances safeness at which the composition is handled so that the environment can be prevented from pollution. “free of” an organic solvent means that no organic solvent is substantially included. The proportion thereof is preferably less than 0.1 percent by mass.

The static surface tension of the curable ink at 25 degrees C. is preferably from 20 to 40 mN/m and more preferably from 28 to 35 mN/m.

The static surface tension was measured at 25 degrees C. with a static surface tensiometer (CBVP-Z, manufactured by Kyowa Interface Science Co., Ltd.). This static surface tension is assumed for the specifications of procurable inkjet discharging head such as GENS manufactured by Ricoh Co., Ltd.

Viscosity

The viscosity of the curable composition has no particular limit and it can be adjusted to suit to a particular application and device. For example, if a discharging device that discharges the composition from nozzles is used, the viscosity thereof is preferably in the range of from 3 to 40 mPa·s, more preferably from 5 to 15 mPa·s, and particularly preferably from 6 to 12 mPa·s in the temperature range of from 20 to 65 degrees C., preferably at 25 degrees C. In addition, it is particularly preferable to satisfy this viscosity range without containing the organic solvent mentioned above. Viscosity can be measured by a cone plate rotary viscometer (VISCOMETER TVE-22L, manufactured by TOKI SANGYO CO., LTD.) using a cone rotor (1°34′×R24) at a rate of rotation of 50 rpm at a temperature of hemathermal circulating water in the range of from 20 to 65 degrees C. VISCOMATE VM-150III can be used for the temperature control of the circulating water.

The pigment dispersion composition preferably has a viscosity change ratio of 15 percent or less, more preferably 10 percent or less, and particularly preferably 5 percent or less. A viscosity change ratio of 15 percent or less enhances the storage stability and dispersibility. The viscosity change rate can be obtained by the following formula (3). Viscosity of the viscosity change ratio can be measured with a cone plate rotary viscometer (VISCOMETER TV-22, manufactured by TOKI SANGYO CO., LTD.) at a rate of rotation of 50 rpm, a temperature of hemathermal circulating water at 25 degrees C., and a shearing speed of 191.4 sec⁻¹.

Viscosity change ratio(percent)=(Viscosity after stored at 70 degrees C. for 14 days−initial viscosity)/(initial viscosity)×100 (3)

Application Field

The application field of the curable composition is not particularly limited. It can be applied to any field where the active energy ray curable composition is used and suitably selected to suit to a particular application. For example, the curable composition is used as a resin for processing, a paint, an adhesive, an insulant, a releasing agent, a coating material, a sealing material, various types of resists, and various types of optical materials.

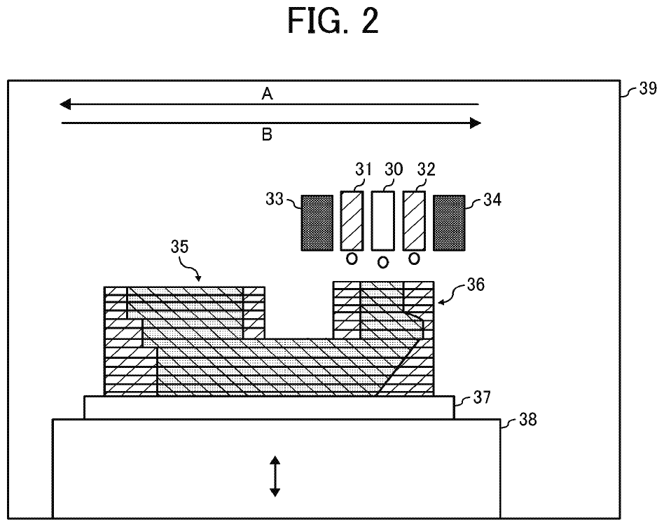

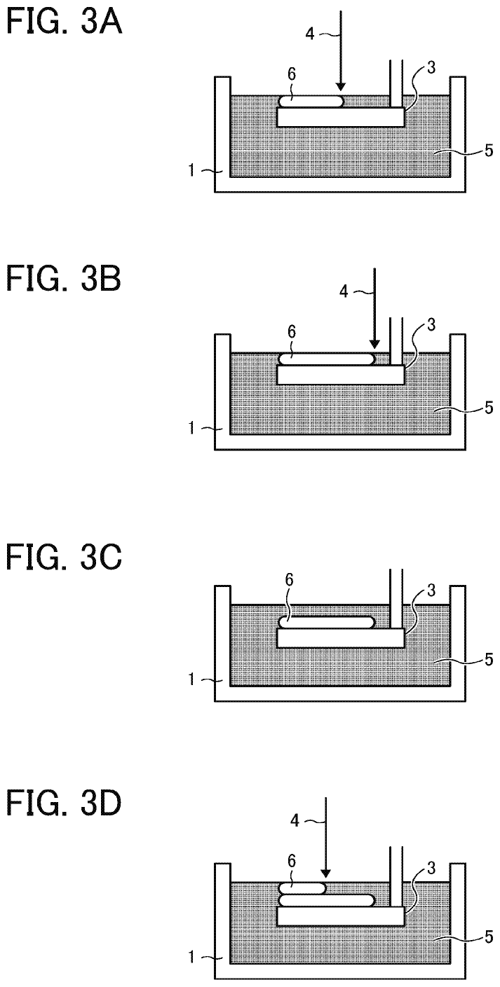

Furthermore, the curable composition can be used as an ink to form two-dimensional texts, images, and designed coating film on various substrates and in addition a solid object forming material to form a three-dimensional image (solid freeform fabrication object). This material for solid freeform fabrication can be used as a binder for powder particles for use in powder additive manufacturing for conducting solid freeform fabrication by repeating curing and laminating powder layers. Also, it can be used as a solid constituting material (modeling material) or supporting member (supporting material) for use in additive manufacturing (stereolithography) method as illustrated in FIG. 2 and FIGS. 3A to 3D.

FIG. 2 is a diagram illustrating a method of discharging the curable composition to a particular region followed by curing upon irradiation of active energy to form a layer and laminating the layers (detail of which is described later).

FIGS. 3A to 3D are diagrams illustrating a method of irradiating a pool (accommodating unit) 1 of a curable composition 5 with active energy 4 to form a cured layer 6 having a particular form on a movable stage 3 and sequentially laminating the cured layer 6 so that a solid freeform fabrication object is obtained.

A device for fabricating a three-dimensional object using the curable composition can be a known device and is not particularly limited. An example of the device includes an accommodating device, a supplying device, and a discharging device of the composition, an active energy irradiator and others.

The present disclosure includes a cured product obtained by curing the curable composition and a processed product obtained by processing a structure having the cured product formed on a substrate. The cured matter or structure having a sheet-like form or film-like form is subjected to molding process such as hot drawing and punching to obtain such a processed product. The processed product is preferably used for, for example, gauges or operation panels of vehicles, office machines, electric and electronic machines, and cameras, which requires surface-processing after decorating the surface.

The substrate is not particularly limited. It can be suitably selected to suit to a particular application. Substances such as paper, fiber, threads, fabrics, leather, metal, plastic, glass, wood, ceramics, or composite materials thereof can be used. Of these, plastic substrates are preferred in terms of processability.

Accommodating Container

The accommodating container of the present disclosure includes a container containing the pigment dispersion composition or curable composition and is suitable as the application described below. For example, if the curable composition is used as ink, the accommodating container containing the ink can be used as an ink cartridge or an ink bottle. Therefore, users can avoid direct contact with the ink during working such as transfer or replacement of the ink, so that fingers and clothes are prevented from getting dirty. Furthermore, it is possible to prevent the ink from being contaminated with foreign matter such as dust. The container can be of any size, any form, and any material. For example, the container can be designed to a particular application. It is preferable that the container be made of a light blocking material to block the light or covered with materials such as a light blocking sheet.

Image Forming Method and Image Forming Device

The image forming device forms two or three dimensional images.

The image-forming device has an accommodating unit containing a curable composition, an applying device to apply the curing composition, a curing device to cure the curing composition, and other optional devices.

Two or three dimensional images are formed executing the image forming method.

The image forming method includes applying a curable composition, curing the curing composition, and other optional processes. Also, it is possible to form two or three dimensional image by inkjetting the curable composition.

The image forming method can be suitably conducted by the image forming apparatus. The application process can be executed by an application device. The curing process can be executed by the curing device. The other optional processes can be executed by the other optional devices.

Accommodating Unit

The accommodating unit is not particularly limited and can be suitably selected to suit to a particular application as long as it can accommodate a curable composition. The accommodating container is preferable as the accommodating unit.

Applying Device and Applying Process

The applying processes is not particularly limited and can be suitably selected to suit to a particular application. For example, the curable composition can be applied by discharging. The discharging device is not particularly limited. Two ways of discharging are a continuous spraying method and an on-demand method. The on-demand method includes, but is not limited to, a piezo method, a thermal method, an electrostatic method.

Curing Device and Curing Process

The curing process is not particularly limited and can be suitably selected to suit to a particular application as long as it can cure a curable composition. The curing process includes heating and irradiation of active energy radiation. Of the two, the latter is preferable.

The device for curing the curable composition utilizes curing upon application of heat or active energy. Curing upon application of active energy is preferable.

The active energy for use in curing the active energy-curable composition is not particularly limited as long as it applies energy required to proceed the polymerization reaction of the polymerizable components in the curable composition. Specific examples include, but are not limited to, electron beams, α rays, β rays, γ rays, and X rays, in addition to ultraviolet rays. In an embodiment in which a particularly high energy light source is used, it obviates the need for a polymerization initiator to proceed polymerization reaction. In the case of irradiation of ultraviolet radiation, there is strong demand for mercury-free procedure to protect the environment. Therefore, superstition with GaN-based ultraviolet light-emitting devices is greatly preferred from industrial and environmental point of view. Furthermore, ultraviolet light-emitting diode (UV-LED) and ultraviolet laser diode (UV-LD) are preferable as ultraviolet ray light source because they have small sizes, long working life, high efficiency, and high cost performance.

Other Device and Other Process

The other processes are not particularly limited and can be suitably selected to suit to a particular application.

The other devices are not particularly limited and can be suitably selected to suit to a particular application.

The image forming device is described with reference to the accompanying drawings.

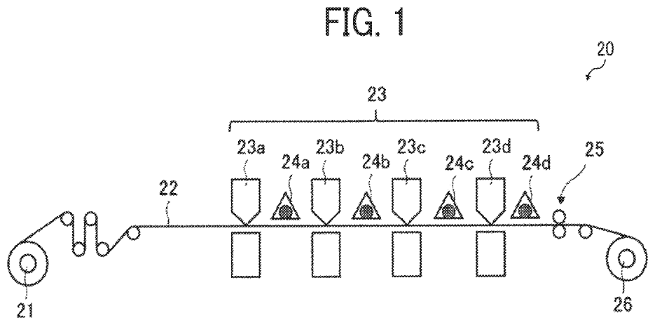

FIG. 1 is a diagram illustrating an image forming device including an inkjet discharging device 20. Printing units 23 (23a, 23b, 23c, and 23d) respectively having ink cartridges and discharging heads for yellow, magenta, cyan, and black curable inks discharge the inks onto a recording medium 22 fed from a supplying roll 21. Thereafter, light sources (irradiators) 24a, 24b, 24c, and 24d emit active energy radiation to the inks to cure, thereby forming a color image. Thereafter, the recording medium 22 is conveyed to a processing unit 25 and a printed matter reeling roll 26. Each of the printing unit 23a, 23b, 23c, and 23d may include a heating assembly to liquidize the ink at the ink discharging unit. Moreover, a mechanism may be optionally disposed which cools down the recording medium to an ambient temperature in a contact or non-contact manner. In addition, the inkjet recording method may be either of a serial method of discharging an ink onto a recording medium by moving the head while the recording medium intermittently moves in accordance with the width of a discharging head or a line method of discharging an ink onto a recording medium from a discharging head fixed at a particular position while continuously moving the recording medium.

The recording medium 22 is not particularly limited.

Specific examples thereof include, but are not limited to, paper, film, metal, or complex materials thereof. The recording medium 22 takes a sheet-like form but is not limited thereto. The image forming device may have a simplex printing configuration capable of printing on one side of a recording medium or a duplex printing configuration capable of printing on both sides thereof.

Optionally, it is possible to print an image with multiple colors with no or faint active energy from the light sources 24a, 24b, and 24c and thereafter expose the image to the active energy radiation from the light source 24d. This configuration saves energy and cost.

The recorded matter having images printed with the ink includes articles having printed images or texts on a plain surface of conventional paper, resin film, etc., articles having printed images or texts on a rough surface, and articles having printed image or texts on a surface made of various materials such as metal or ceramic. It is possible to form an image partially with solid feeling (formed of two dimensional images and three dimensional images) or a solid object by laminating two dimensional images.

FIG. 2 is a schematic diagram illustrating an example of another image forming device (device for fabricating a three-dimensional image). An image forming device 39 illustrated in FIG. 2 forms laminated layers while discharging a first curable composition from a discharging head unit 30 for fabrication object and a second curable composition composed of different ingredients from the first curable composition from discharging head units 31 and 32 for a support by using a head unit having inkjet heads arranged movable in the directions indicated by the arrows A and B and curing each composition by ultraviolet irradiators 33 and 34 placed adjacent to the discharging head units 31 and 32. More specifically, for example, after the discharging head units 31 and 32 for a support discharge the second curable composition onto a support substrate 37 for fabrication object and the second active energy curable composition is solidified upon application of irradiation of active energy to form a first support layer having a pool, the discharging head unit 30 for fabrication object discharges the first curable composition onto the pool followed by irradiation of active energy for solidification, thereby forming a first fabrication layer. This step is repeated multiple times in accordance with the required number of lamination while moving the stage 38 up and down in the vertical direction to laminate the support layer and the fabrication layer to manufacture a solid freeform fabrication object 35. Thereafter, a laminated support 36 is removed, if desired. Although there is only one of the discharging head unit 30 for fabrication illustrated in FIG. 2, the device may have two or more discharging head units 30.

Cured Matter

The cured matter is a two or three dimensional image. The two or three dimensional image is formed by applying a curable composition to a substrate and curing it.

The two or three dimensional image includes a product having printed images or texts on the plain surface of conventional paper, resin film, and other media, products having printed image or texts on a rough printing surface, and products having printed image or texts on a surface made of various materials such as metal or ceramic.

The two dimensional image include, but is not limited to, texts, symbols, figures, their combination, and solid images.

The three dimensional image include, but is not limited to, a solid freeform fabrication object.

The average thickness of a solid freeform fabrication object is not particularly limited and can be suitably selected to suit to a particular application. A layer thickness of 10 μm or above is preferable.

The two or three dimensional image is preferably formed by curing with a light-emitting diode at a cumulative irradiance of active energy of 500 mJ/cm² or less.

The extensibility of cured matter at 180 degrees C. is preferably 50 percent or more and more preferably 100 percent or more when represented as the ratio of (length after tensile test−length before tensile test) to (length before tensile test).

Decoration

The decoration includes a substrate and a decorative portion on the substrate.

The substrate is not particularly limited. It can suitably be selected to suit to a particular application. Specific examples include, but are not limited to, paper, thread, fiber, fabrics, leather, metal, plastic, glass, wood, ceramics, or composite materials thereof. Of these, plastic substrates are preferred in terms of processability.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, embodiments of the present disclosure are described in detail with reference to Examples but not limited thereto.

Amine Value of Dispersant Polymer

A total of 1 g of a dispersant polymer was dissolved in 100 mL of methylisobutylketone and the solution was subjected to potentiometric titration with methylisobutylketone chlorate solution at 0.01 mol/L. The amine value was determined on a basis of the obtained voltage. An automatic titrator (GT-200, manufactured by Mitsubishi Chemical Analytic) was used for the potentiometric titration.

### Example 1-1

Preparation of Pigment Dispersion Composition A dispersant polymer (AJISPER PB821, amine value of 10.0 mgKOH/g, manufactured by Ajinomoto Fine-Techno Co., Inc.) at 6.0 parts was placed in phenoxyethyl acrylate at 79.0 parts by mass followed by stirring at 25 degrees C. for four hours to prepare a dispersion medium.

Zirconia balls with a diameter of 2 mm at 80 parts, strontium titanate (SW-100, manufactured by Titan Kogyo, Ltd.) at 3.75 parts, and the prepared dispersion medium at 21.25 parts were placed in a 50 mL bottle of mayonnaise (UM sample bottle, manufactured by AS ONE Corporation). The resulting mixture was dispersed with a ball mill for two days under the following conditions to prepare a pigment dispersion composition (pigment concentration of 15 percent by mass).

The number average primary particle diameter of the pigment in the pigment dispersion composition was from 100 to 300 nm. The number average primary particle diameter was obtained from the average of the cumulative distribution obtained by measuring the diameters in a certain direction of 200 to 500 primary particles sandwiched between two parallel lines drawn along a certain direction with a scanning electron microscope (SU3500, manufactured by Hitachi High-Technologies Corporation) in a 10,000× magnification field.

Ball Mill Used

Media: YTZ ball diameter of 5 mm (Zirconia ball, manufactured by NIKKATO CORPORATION)

Mill: MIX-ROTAR VMR-5 (manufactured by AS ONE Corporation)

Rate of rotation: 75 rpm (rate of rotation of mayonnaise bottle)

### Examples 1-2 to 1-50 and Comparative Examples 1-1 to 1-10

Pigment dispersion composition of Examples 1-2 to 1-50 and Comparative Examples 1-1 to 1-10 were prepared in the same manner as in Example 1-1 except that the white pigment, the pigment dispersion composition, and the polymerizable compound were changed to the combinations shown in Tables 1 to 3.

The number average primary particle diameters of the pigment of Examples 1-2 to 1-50 and Comparative Examples 1-1 to 1-10 were measured in the same manner as for the pigment dispersion composition of Example 1-1. The number average primary particle diameter of the pigment in the pigment dispersion composition was from 100 to 300 nm.

The pigment dispersion compositions of Examples 1-1 to 1-50 and Comparative Examples 1-1 to 1-10 was evaluated on storage stability.

The evaluation results are shown in Tables 1 to 3.

Storage Stability

Immediately after each of the pigment dispersion compositions was prepared, the initial viscosity thereof was measured using a cone plate type rotatory viscometer (VISCOMETER TV-22, manufactured by TOKI SANGYO CO., LTD.) under such conditions that the temperature of the hemathermal cycling water was 25 degrees C., the rotational frequency was 50 rpm, and the shearing speed was 191.4 sec⁻¹. Each of the pigment dispersion compositions was left to rest at 70 degrees C. for 14 days. Thereafter, the viscosity after the storage was measured under the same conditions as the initial viscosity. The viscosity change ratio was calculated according to the following formula (4) and used to evaluate the storage stability according to the following evaluation criteria. The storage stability becomes excellent as the viscosity change ratio decreases.

Viscosity change ratio(percent)=(Viscosity after stored at 70 degrees C. for 14 days−initial viscosity)/(initial viscosity)×100 (4)

Evaluation Criteria

A: Viscosity change ratio is 5 percent or less
B: Viscosity change ratio is from greater than 5 percent to 15 percent
C: Viscosity change ratio is from greater than 5 percent to less than 30 percent
D: Viscosity change ratio is greater than 30 percent

TABLE 1

| | White pigment | | | Pigment dispersant | | |
|---|---|---|---|---|---|---|
| | | | Proportion | | | Proportion |
| | | | (percent by | | Amine value | (percent by |
| Example | Compound | Product | mass) | Name | (mgKOH/g) | mass) |
| 1-1 | Strontium | SW-100 | 15 | AJISPER PB 821 | 10.0 | 6 |
| | titanate | | | | | |
| 1-2 | Strontium | SW-100 | 15 | DISPERBYK-180 | 94.0 | 6 |
| | titanate | | | | | |
| 1-3 | Strontium | SW-100 | 15 | AJISPER PB 821 | 10.0 | 6 |
| | titanate | | | | | |
| 1-4 | Strontium | SW-100 | 15 | DISPERBYK-180 | 94.0 | 6 |
| | titanate | | | | | |
| 1-5 | Strontium | SW-100 | 15 | Solsperse 71000 | 75.0 | 6 |
| | titanate | | | | | |
| 1-6 | Strontium | SW-100 | 15 | Solsperse 73000 | 80.0 | 6 |
| | titanate | | | | | |
| 1-7 | Strontium | SW-100 | 15 | Solsperse 74000 | 81.0 | 6 |
| | titanate | | | | | |
| 1-8 | Strontium | SW-100 | 15 | Solsperse 88000 | 33.0 | 6 |
| | titanate | | | | | |
| 1-9 | Strontium | SW-100 | 15 | DISPERBYK-9151 | 45.1 | 6 |
| | titanate | | | | | |
| 1-10 | Strontium | SW-350 | 15 | DISPERBYK-180 | 94.0 | 6 |
| | titanate | | | | | |
| 1-11 | Strontium | SW-350 | 15 | AJISPER PB 821 | 10.0 | 6 |
| | titanate | | | | | |
| 1-12 | Strontium | SW-350 | 15 | DISPERBYK-180 | 17.0 | 6 |
| | titanate | | | | | |
| 1-13 | Strontium | SW-350 | 15 | AJISPER PB 821 | 10.0 | 6 |
| | titanate | | | | | |
| 1-14 | Strontium | SW-350 | 30 | DISPERBYK-180 | 94.0 | 6 |
| | titanate | | | | | |
| 1-15 | Strontium | SW-350 | 15 | Solsperse 71000 | 75.0 | 6 |
| | titanate | | | | | |
| 1-16 | Strontium | SW-350 | 15 | Solsperse 73000 | 80.0 | 6 |
| | titanate | | | | | |
| 1-17 | Strontium | SW-350 | 15 | Solsperse 74000 | 81.0 | 6 |
| | titanate | | | | | |
| 1-18 | Strontium | SW-350 | 15 | Solsperse 88000 | 33.0 | 6 |
| | titanate | | | | | |
| 1-19 | Strontium | SW-350 | 15 | DISPERBYK-9151 | 45.1 | 6 |
| | titanate | | | | | |
| 1-20 | Strontium | SW-350 | 15 | DISPERBYK-180 | 94.0 | 6 |
| | titanate | | | | | |

| | Dispersion medium | | | |
|---|---|---|---|---|
| | | | Proportion | Storage Stability |
| Example | Compound | SP value | (percent by mass) | Viscosity change ratio |
| 1-1 | PEA | 9.99 | 79 | −1 |
| 1-2 | PEA | 9.99 | 79 | 1 |
| 1-3 | ACMO | 11.55 | 79 | 2 |
| 1-4 | ACMO | 11.55 | 79 | 4 |
| 1-5 | THFA | 9.97 | 79 | 1 |
| 1-6 | THFA | 9.97 | 79 | 3 |
| 1-7 | ME-4S | 10.15 | 79 | 3 |
| 1-8 | HBA | 11.31 | 79 | 3 |
| 1-9 | FA-512AS | 10.44 | 79 | −2 |
| 1-10 | FA-513AS | 10.35 | 79 | −4 |
| 1-11 | PEA | 9.99 | 79 | −2 |
| 1-12 | PEA | 9.99 | 79 | 5 |
| 1-13 | PEA | 9.99 | 79 | 7 |
| 1-14 | ACMO | 11.55 | 64 | 9 |
| 1-15 | ACMO | 11.55 | 79 | 7 |
| 1-16 | THEA | 9.97 | 79 | 5 |
| 1-17 | HBA | 11.31 | 79 | 3 |
| 1-18 | HBA | 11.31 | 79 | −7 |
| 1-19 | FA-512AS | 10.44 | 79 | −6 |
| 1-20 | FA-513AS | 10.35 | 79 | −8 |

TABLE 2

| | White pigment | | | Pigment dispersant | | |
|---|---|---|---|---|---|---|
| | | | Proportion | | Amine | Proportion |
| | | | (percent by | | value | (percent by |
| Example | Compound | Product | mass) | Name | (mgKOH/g) | mass) |
| 1-21 | Calcium | TC-110 | 15 | AJISPER PB821 | 10.0 | 6 |
| | titanate | | | | | |
| 1-22 | Calcium | TC-110 | 15 | DISPERBYK- 180 | 94.0 | 6 |
| | titanate | | | | | |
| 1-23 | Calcium | TC-110 | 30 | AJISPER PB821 | 10.0 | 6 |
| | titanate | | | | | |
| 1-24 | Calcium | TC-110 | 50 | DISPERBYK-180 | 94.0 | 6 |
| | titanate | | | | | |
| 1-25 | Calcium | TC-110 | 15 | Solsperse 71000 | 75.0 | 5 |
| | titanate | | | | | |
| 1-26 | Calcium | TC-110 | 15 | Solsperse 73000 | 80.0 | 6 |
| | titanate | | | | | |
| 1-27 | Calcium | TC-110 | 15 | Solsperse 74000 | 81.0 | 6 |
| | titanate | | | | | |
| 1-28 | Calcium | TC-110 | 15 | Solsperse 88000 | 33.0 | 6 |
| | titanate | | | | | |
| 1-29 | Calcium | TC-110 | 15 | DISPERBYK-9151 | 45.1 | 6 |
| | titanate | | | | | |
| 1-30 | Calcium | TC-110 | 15 | DISPERBYK-180 | 94.0 | 6 |
| | titanate | | | | | |
| 1-31 | Zinc | SACHTORITH | 15 | AJISPER PB821 | 10.0 | 6 |
| | sulfide | HD-S | | | | |
| 1-32 | Zinc | SACHTORITH | 15 | DISPERBYK-180 | 17.0 | 6 |
| | sulfide | HD-S | | | | |
| 1-33 | Zinc | SACHTORITH | 30 | AJISPER PB821 | 10.0 | 6 |
| | sulfide | HD-S | | | | |
| 1-34 | Zinc | SACHTORITH | 15 | DISPERBYK-180 | 94.0 | 6 |
| | sulfide | HD-S | | | | |
| 1-35 | Zinc | SACHTORITH | 30 | DISPERBYK-180 | 94.0 | 6 |
| | sulfide | HD-S | | | | |
| 1-36 | Zinc | SACHTORITH | 15 | Solsperse 73000 | 80.0 | 6 |
| | sulfide | HD-S | | | | |
| 1-37 | Zinc | SACHTORITH | 15 | Solsperse 74000 | 81.0 | 6 |
| | sulfide | HD-S | | | | |
| 1-38 | Zinc | SACHTORITH | 15 | Solsperse 88000 | 33.0 | 6 |
| | sulfide | HD-S | | | | |
| 1-39 | Zinc | SACHTORITH | 15 | DISPERBYK-9151 | 45.1 | 6 |
| | sulfide | HD-S | | | | |
| 1-40 | Zinc | SACHTORITH | 15 | DISPERBYK-180 | 94.0 | 6 |
| | sulfide | HD-S | | | | |
| 1-41 | Strontium | SW-100 | 15 | AJISPER PB821 | 10.0 | 6 |
| | titanate | | | | | |
| 1-42 | Strontium | SW-100 | 15 | DISPERBYK-180 | 17.0 | 6 |
| | titanate | | | | | |
| 1-43 | Strontium | SW-100 | 15 | AJISPER PB821 | 10.0 | 6 |
| | titanate | | | | | |
| 1-44 | Strontium | SW-350 | 15 | DISPERBYK-180 | 17.0 | 6 |
| | titanate | | | | | |
| 1-45 | Strontium | SW-350 | 15 | AJISPER PB821 | 10.0 | 6 |
| | titanate | | | | | |
| 1-46 | Calcium | TC-110 | 15 | DISPERBYK-180 | 17.0 | 6 |
| | titanate | | | | | |
| 1-47 | Calcium | TC-110 | 15 | AJISPER PB821 | 10.0 | 6 |
| | titanate | | | | | |
| 1-48 | Zinc | SACHTORITH | 15 | DISPERBYK-180 | 17.0 | 6 |
| | sulfide | HD-S | | | | |
| 1-49 | Zinc | SACHTORITH | 15 | AJISPER PB821 | 10.0 | 6 |
| | sulfide | HD-S | | | | |
| 1-50 | Zinc | SACHTORITH | 15 | DISPERBYK-180 | 17.0 | 6 |
| | sulfide | HD-S | | | | |

| | Dispersion medium | | | |
|---|---|---|---|---|
| | | | Proportion | Storage Stability |
| Example | Compound | SP value | (percent by mass) | Viscosity change ratio |
| 1-21 | PEA | 9.99 | 79 | 5 |
| 1-22 | PEA | 9.99 | 79 | 6 |
| 1-23 | ACMO | 11.55 | 64 | 7 |
| 1-24 | ACMO | 11.55 | 44 | 5 |
| 1-25 | THEA | 9.97 | 80 | 7 |
| 1-26 | THFA | 9.97 | 79 | 8 |
| 1-27 | ME-4S | 10.15 | 79 | 4 |
| 1-28 | HBA | 11.31 | 79 | 9 |
| 1-29 | FA-512AS | 10.44 | 79 | 9 |
| 1-30 | FA-513AS | 10.35 | 79 | 8 |
| 1-31 | PEA | 9.99 | 79 | 9 |
| 1-32 | PEA | 9.99 | 79 | 10 |
| 1-33 | PEA | 9.99 | 64 | 10 |
| 1-34 | ACMO | 11.55 | 79 | 10 |
| 1-35 | ACMO | 11.55 | 64 | 9 |
| 1-36 | THEA | 9.97 | 79 | 7 |
| 1-37 | RBA | 11.31 | 79 | 8 |
| 1-38 | HBA | 11.31 | 79 | 6 |
| 1-39 | FA-512AS | 10.44 | 79 | 7 |
| 1-40 | FA-513AS | 10.35 | 79 | 9 |
| 1-41 | IBXA | 7.24 | 79 | 28 |
| 1-42 | IBXA | 7.24 | 79 | 24 |
| 1-43 | S-1800A | 8.23 | 79 | 19 |
| 1-44 | IBXA | 7.24 | 79 | 22 |
| 1-45 | IBXA | 7.24 | 79 | 16 |
| 1-46 | IBXA | 7.24 | 79 | 28 |
| 1-47 | IBXA | 7.24 | 79 | 20 |
| 1-48 | IBXA | 7.24 | 79 | 15 |
| 1-49 | IBXA | 7.24 | 79 | 17 |
| 1-50 | S-1800A | 8.23 | 79 | 21 |

TABLE 3

| | White pigment | | | Pigment dispersant | | |
|---|---|---|---|---|---|---|
| | | | Proportion | | Amine | Proportion |
| Comparative | | | (percent | | value | (percent |
| Example | Compound | Product | by mass) | Name | (mgKOH/g) | by mass) |
| 1-1 | Titanium | JR405 | 15 | AJISPER | 10.0 | 6 |
| | Oxide | | | PB821 | | |
| 1-2 | Titanium | JR405 | 15 | DISPERBYK- | 94.0 | 6 |
| | Oxide | | | 180 | | |
| 1-3 | Titanium | JR405 | 15 | AJISPER | 10.0 | 6 |
| | Oxide | | | PB821 | | |
| 1-4 | Titanium | JR405 | 15 | DISPERBYK- | 94.0 | 6 |
| | Oxide | | | 180 | | |
| 1-5 | Titanium | JR405 | 15 | Solsperse | 75.0 | 6 |
| | Oxide | | | 71000 | | |
| 1-6 | Titanium | JR405 | 15 | Solsperse | 80.0 | 6 |
| | Oxide | | | 73000 | | |
| 1-7 | Strontium | SW-100 | 15 | Solsperse | 0.0 | 6 |
| | titanate | | | 54000 | | |
| 1-8 | Strontium | SW-350 | 15 | Solsperse | 0.0 | 6 |
| | titanate | | | 54000 | | |
| 1-9 | Calcium | TC-110 | 15 | Solsperse | 0.0 | 6 |
| | titanate | | | 54000 | | |
| 1-10 | Zinc | SACHTORITH | 15 | Solsperse | 0.0 | 6 |
| | sulfide | HD-S | | 54000 | | |

| | | | | Storage |
|---|---|---|---|---|
| | Dispersion medium | | | Stability |
| | | | Proportion | Viscosity |
| Comparative | | SP | (percent by | change |
| Example | Compound | value | mass) | ratio |
| 1-1 | IBXA | 7.24 | 79 | 121 |
| 1-2 | IBXA | 7.24 | 79 | 210 |
| 1-3 | S-1800A | 8.23 | 79 | 176 |
| 1-4 | S-1800A | 8.23 | 79 | 455 |
| 1-5 | MEDOL- | 8.59 | 79 | 104 |
| | 10 | | | |
| 1-6 | MEDOL- | 8.59 | 79 | 156 |
| | 10 | | | |
| 1-7 | ACMO | 11.55 | 79 | 289 |
| 1-8 | PEA | 9.99 | 79 | 295 |
| 1-9 | ACMO | 11.55 | 79 | 390 |
| 1-10 | MEDOL- | 8.59 | 79 | 882 |
| | 10 | | | |

The product and the manufacturing companies of the ingredients in Tables 1 to 3 are as follows.

White Pigment

SW-100: strontium titanate, manufactured by Titan Kogyo, Ltd.

SW-350: strontium titanate, manufactured by Titan Kogyo, Ltd.

TC-110: strontium titanate, manufactured by Titan Kogyo, Ltd.

SACHTORITH HD-S: zinc sulfide, manufactured by Connel Brothers Japan

JR405: titanium dioxide, manufactured by TAYCA CORPORATION

Dispersant Polymer

Solsperse 54000 (amine value of 0.0 mgKOH/g, manufactured by Lubrizol Japan Ltd.)

Solsperse 71000 (amine value of 75.0 mgKOH/g, manufactured by Lubrizol Japan Ltd.)

Solsperse 73000 (amine value of 80.0 mgKOH/g, manufactured by Lubrizol Japan Ltd.)

Solsperse 74000 (amine value of 81.0 mgKOH/g, manufactured by Lubrizol Japan Ltd.)

Solsperse 88000 (amine value of 33.0 mgKOH/g, manufactured by Lubrizol Japan Ltd.)

AJISPER PB-821 (amine value of 10.0 mgKOH/g, manufactured by Ajinomoto Fine-Techno Co., Inc.)

BYKJET-9151 (amine vlaue of 17.2 mgKOH/g, manufactured by BYK Japan KK.)

DISPERBYK-180 (amine vlaue of 140 mgKOH/g, manufactured by BYK Japan KK.)

Polymerizable Compound

Acryloylmorpholine (ACMO, SP value of 11.55, manufactured by KJ Chemicals Corporation)

Methoxy tetraethylene glycol acrylate (EO modified), (ME-4S, SP value of 10.15, manufactured by DKS Co., Ltd.)

4-hydroxybutyl acrylate (HBA, SP value of 11.31, manufactured by Mitsubishi Chemical Corporation)

Dicyclopentenyl oxyethyl acrylate (FA-512AS, SP Value of 10.44, manufactured by Hitachi Chemical Co., Ltd.)

Dicyclopentenyl oxyethyl acrylate (FA-513AS, SP Value of 10.35, manufactured by Hitachi Chemical Co., Ltd.)

Phenoxyethyl acrylate (PEA in Table, VISCOAT® #192, SP value of 9.99, manufactured by OSAKA ORGANIC CHEMICAL INDUSTRY LTD.)

Tetrahydrofurfuryl acrylate: THFA (SP value of 9.97, manufactured by OSAKA ORGANIC CHEMICAL INDUSTRY LTD.)

Isobornyl acrylate (IBXA, SP value of 7.24, manufactured by OSAKA ORGANIC CHEMICAL INDUSTRY LTD.)

Isostearyl acrylate (S-1800A, SP value of 8.23, manufactured by Shin-Nakamura Chemical Co., Ltd.)

(2-methyl-2-ethyl-1,3-dioxolane-4-yl)methyl acrylate (MEDOL-10, SP value of 8.59, manufactured by OSAKA ORGANIC CHEMICAL INDUSTRY LTD.)

### Example 2-1

Preparation of Curable Composition

The following recipe was mixed to obtain a curable composition:

Pigment dispersion composition 1 (obtained in Example 1-1): 20.0 parts

Phenoxy ethylacrylate: 20.0 parts

Acryloylmorpholine: 20.0 parts

Isobolonyl acrylate: 10.0 parts

Tetrahydro furfuryl acrylate: 5.0 parts

1,9-Nonane diol diacrylate: 5.0 parts

Trimethylol propane triacrylate: 5.0 parts

Tricyclodecane dimethanol diacrylate: 2.0 parts

Acrylate of c-caprolactone modified dipentaerythritol: 2.0 parts

Urethane acrylate resin: 0.5 parts

Surfactant (WET 270): 0.3 parts

Polymerization initiator (Darocure TPO): 5.0 parts

Polymerization initiator (Irgacure819): 3.0 parts

Polymerization initiator (SpeedcureDETX): 2.0 parts

4-methoxyphenol: 0.2 parts

### Examples 2-1 to 2-50 and Comparative Examples 2-1 to 2-10

Curable compositions were obtained in the same manner as in Examples 2-1 except that each component was changed to the combinations shown in Tables 4 to 9. The assigned numbers 1-1 to 1-50 as the types of the white pigments in Tables 4 to 8 represent the pigment dispersion compositions prepared in Examples 1-1 to 1-50. The assigned numbers 1-1 to 1-6 shown as the types of the white pigments in Table 9 represent the pigment dispersion compositions prepared in Examples 1-1 to 1-6.

TABLE 4

| | | | Example | | | | |
|---|---|---|---|---|---|---|---|
| | | | 2-1 | 2-2 | 2-3 | 2-4 | 2-5 |
| Liquid dispersion of white | | Type | 1-1 | 1-2 | 1-3 | 1-4 | 1-5 |
| pigment | | Proportion (percent | 20.0 | 20.5 | 20.5 | 20.5 | 20.5 |
| | | by mass) | | | | | |
| Polymerizable | Monofunctional | Phenoxyethyl | 20 | 10 | 20 | | 20 |
| compound | compound | acrylate | | | | | |
| | | Acryloylmorpholine | 20 | 20 | 20 | 20 | 20 |
| | | Isobornyl acrylate | 10 | 10 | 10 | 20 | 10 |
| | | Benzyl acrylate | | 10 | | 5 | |
| | | Tetrahydro furfuryl | 5 | 5 | 5 | | 5 |
| | | acrylate | | | | | |
| | | HBA | | 5 | | 4 | |
| | | ME-4S | | | | 5 | |
| | | V#150D | | | | 5 | |
| | | FA-512AS | | | | | |
| | Polyfunctional | 1,9-Nonane diol | 5 | | 5 | 2 | |
| | compound | diacrylate | | | | | |
| | | TMPTA | 5 | 5 | 5 | | 2 |
| | | KAYARAD R-684 | 2 | 2 | 2 | 2 | 2 |
| | | KAYARAD DPCA- | 2 | 2 | | | 2 |
| | | 60 | | | | | |
| Oligomer | | UV-3010 | | | | | 2 |
| | | CN963J85 | 0.5 | | 2 | 2 | 2 |
| Surfactant | | BYK-3575 | | | | | |
| | | WET270 | 0.3 | 0.3 | 0.3 | 0.3 | 0.3 |
| Polymerization initiator | | Darocure TPO | 5 | 5 | 5 | | |
| | | Irgacure 819 | 3 | 3 | 3 | | |
| | | BMS | | | | 7 | 7 |
| | | PBZ | | | | | |
| | | Speedcure DETX | 2 | 2 | 2 | | |
| Hydrogen donor | | KAYACURE PEA | | | | 7 | 7 |
| Polymerization inhibitor | | 4-Methoxyphenol | 0.2 | 0.2 | 0.2 | 0.2 | 0.2 |
| Total (Percent by mass) | | | 100 | 100 | 100 | 100 | 100 |
| | | | Example | | | | |
| | | | 2-6 | 2-7 | 2-8 | 2-9 | 2-10 |
| Liquid dispersion of white | | Type | 1-6 | 1-7 | 1-8 | 1-9 | 1-10 |
| pigment | | Proportion (percent | 20.5 | 20.5 | 20.5 | 20.5 | 20.5 |
| | | by mass) | | | | | |
| Polymerizable | Monofunctional | Phenoxyethyl | | 20 | | 20 | 15 |
| compound | compound | acrylate | | | | | |
| | | Acryloylmorpholine | 20 | 20 | 30 | 20 | 15 |
| | | Isobornyl acrylate | 10 | 10 | 10 | 10 | 5 |
| | | Benzyl acrylate | | | 20 | | |
| | | Tetrahydro furfuryl | 20 | 5 | | 3 | 5 |
| | | acrylate | | | | | |
| | | HBA | 4 | | | | |
| | | ME-4S | 2 | | 3 | | 5 |
| | | V#150D | 5 | | | | 5 |
| | | FA-512AS | 5 | | 3 | | |
| | Polyfunctional | 1,9-Nonane diol | | 5 | | 3 | 4 |
| | compound | diacrylate | | | | | |
| | | TMPTA | 2 | 5 | | 3 | 5 |
| | | KAYARAD R-684 | | | | 2 | 2 |
| | | KAYARAD DPCA- | 2 | 2 | | 2 | 2 |
| | | 60 | | | | | |

| | | | | | | |
|---|---|---|---|---|---|---|
| Oligomer | UV-3010 | | 2 | | | |
| | CN963J85 | | 2 | 2 | 2 | |
| Surfactant | BYK-3575 | 0.3 | 0.3 | 0.3 | 0.3 | 0.3 |
| | WET270 | | | | | |
| Polymerization initiator | Darocure TPO | 7 | 8 | 9 | | |
| | Irgacure 819 | | | | | |
| | BMS | | | | | |
| | PBZ | | | | 7 | 7 |
| | Speedcure DETX | 2 | 2 | 2 | | |
| Hydrogen donor | KAYACURE PEA | | | | 7 | 7 |
| Polymerization inhibitor | 4-Methoxyphenol | 0.2 | 0.2 | 0.2 | 0.2 | 0.2 |

| | | | | | |
|---|---|---|---|---|---|
| Total (Percent by mass) | 100 | 100 | 100 | 100 | 100 |

TABLE 5

| | | | Example | | | | |
|---|---|---|---|---|---|---|---|
| | | | 2-11 | 2-12 | 2-13 | 2-14 | 2-15 |
| Liquid dispersion of white | | Type | 1-11 | 1-12 | 1-13 | 1-14 | 1-15 |
| pigment | | Percent (percent by | 21 | 21 | 21 | 21 | 21 |
| | | mass) | | | | | |
| Polymerizable | Monofunctional | Phenoxyethyl | 20 | 10 | 20 | | 20 |
| compound | compound | acrylate | | | | | |
| | | Acryloylmorpholine | 20 | 20 | 20 | 20 | 20 |
| | | Isobornyl acrylate | 10 | 10 | 10 | 20 | 10 |
| | | Benzyl acrylate | | 10 | | 5 | |
| | | Tetrahydro furfuryl | 5 | 5 | 5 | | 5 |
| | | acrylate | | | | | |
| | | Hydroxybutyl | | 5 | | 4 | |
| | | acrylate | | | | | |
| | | ME-4S | | | | 5 | |
| | | V#150D | | | | 5 | |
| | | FA-512AS | | | | | |
| | Polyfunctional | 1,9-Nonane diol | 5 | | 5 | 2 | |
| | compound | diacrylate | | | | | |
| | | TMPTA | 5 | 5 | 5 | | 2 |
| | | KAYARAD R-684 | 2 | 2 | 2 | 2 | 2 |
| | | KAYARAD DPCA- | 2 | 2 | | | 2 |
| | | 60 | | | | | |
| Oligomer | | UV-3010 | | | | | 2 |
| | | CN963J85 | | | 2 | 2 | 2 |
| Surfactant | | BYK-3575 | | | | | |
| | | WET270 | 0.3 | 0.3 | 0.3 | 0.3 | 0.3 |
| Polymerization initiator | | Darocure TPO | 5 | 5 | 5 | | |
| | | Irgacure 819 | 3 | 3 | 3 | | |
| | | BMS | | | | 7 | 7 |
| | | PBZ | | | | | |
| | | Speedcure DETX | 2 | 2 | 2 | | |
| Hydrogen donor | | KAYACURE PEA | | | | 7 | 7 |
| Polymerization inhibitor | | 4-Methoxyphenol | 0.2 | 0.2 | 0.2 | 0.2 | 0.2 |
| Total (Percent by mass) | | | 100 | 100 | 100 | 100 | 100 |
| | | | Example | | | | |
| | | | 2-16 | 2-17 | 2-18 | 2-19 | 2-20 |
| Liquid dispersion of white | | Type | 1-16 | 1-17 | 1-18 | 1-19 | 1-20 |
| pigment | | Percent (percent by | 21 | 21 | 21 | 21 | 21 |
| | | mass) | | | | | |
| Polymerizable | Monofunctional | Phenoxyethyl | | 20 | | 20 | 15 |
| compound | compound | acrylate | | | | | |
| | | Acryloylmorpholine | 20 | 20 | 30 | 20 | 15 |
| | | Isobornyl acrylate | 10 | 10 | 10 | 10 | 5 |
| | | Benzyl acrylate | | | 20 | | |
| | | Tetrahydro furfuryl | 20 | 5 | | 3 | 5 |
| | | acrylate | | | | | |
| | | Hydroxybutyl | 4 | | | | |
| | | acrylate | | | | | |
| | | ME-4S | 2 | | 3 | | 5 |
| | | V#150D | 5 | | | | 5 |
| | | FA-512AS | 5 | | 3 | | |
| | Polyfunctional | 1,9-Nonane diol | | 5 | | 3 | 4 |
| | compound | diacrylate | | | | | |
| | | TMPTA | 2 | 5 | | 3 | 5 |
| | | KAYARAD R-684 | | | | 2 | 2 |
| | | KAYARAD DPCA- | 2 | 2 | | 2 | 2 |
| | | 60 | | | | | |

| | | | | | | |
|---|---|---|---|---|---|---|
| Oligomer | UV-3010 | | 2 | | | |
| | CN963J85 | | | 2 | 2 | 2 |
| Surfactant | BYK-3575 | 0.3 | 0.3 | 0.3 | 0.3 | 0.3 |
| | WET270 | | | | | |
| Polymerization initiator | Darocure TPO | 7 | 8 | 9 | | |
| | Irgacure 819 | | | | | |
| | BMS | | | | | |
| | PBZ | | | | 7 | 7 |
| | Speedcure DETX | 2 | 2 | 2 | | |
| Hydrogen donor | KAYACURE PEA | | | | 7 | 7 |
| Polymerization inhibitor | 4-Methoxyphenol | 0.2 | 0.2 | 0.2 | 0.2 | 0.2 |

| | | | | | |
|---|---|---|---|---|---|
| Total (Percent by mass) | 100 | 100 | 100 | 100 | 100 |

| | | | Example | | | | |
|---|---|---|---|---|---|---|---|
| | | | 2-21 | 2-22 | 2-23 | 2-24 | 2-25 |
| Liquid dispersion of white | | Type | 1-21 | 1-22 | 1-23 | 1-24 | 1-25 |
| pigment | | Percent (percent by | 21 | 21 | 21 | 21 | 21 |
| | | mass) | | | | | |
| Polymerizable | Monofunctional | Phenoxyethyl | 20 | 10 | 20 | | 20 |
| compound | compound | acrylate | | | | | |
| | | Acryloylmorpholine | 20 | 20 | 20 | 20 | 20 |
| | | Isobornyl acrylate | 10 | 10 | 10 | 20 | 10 |
| | | Benzyl acrylate | | 10 | | 5 | |
| | | Tetrahydro furfuryl | 5 | 5 | 5 | | 5 |
| | | acrylate | | | | | |
| | | Hydroxybutyl | | 5 | | 4 | |
| | | acrylate | | | | | |
| | | ME-4S | | | | 5 | |
| | | V#150D | | | | 5 | |
| | | FA-512AS | | | | | |
| | Polyfunctional | 1,9-Nonane diol | 5 | | 5 | 2 | |
| | compound | diacrylate | | | | | |
| | | TMPTA | 5 | 5 | 5 | | 2 |
| | | KAYARAD R-684 | 2 | 2 | 2 | 2 | 2 |
| | | KAYARAD DPCA- | 2 | 2 | | | 2 |
| | | 60 | | | | | |
| Oligomer | | UV-3010 | | | | | 2 |
| | | CN963J85 | | | 2 | 2 | 2 |
| Surfactant | | BYK-3575 | | | | | |
| | | WET270 | 0.3 | 0.3 | 0.3 | 0.3 | 0.3 |
| Polymerization initiator | | Darocure TPO | 5 | 5 | 5 | | |
| | | Irgacure 819 | 3 | 3 | 3 | | |
| | | BMS | | | | 7 | 7 |
| | | PBZ | | | | | |
| | | Speedcure DETX | 2 | 2 | 2 | | |
| Hydrogen donor | | KAYACURE PEA | | | | 7 | 7 |
| Polymerization inhibitor | | 4-methoxyphenol | 0.2 | 0.2 | 0.2 | 0.2 | 0.2 |
| Total (Percent by mass) | | | 100 | 100 | 100 | 100 | 100 |
| | | | Example | | | | |
| | | | 2-26 | 2-27 | 2-28 | 2-29 | 2-30 |
| Liquid dispersion of white | | Type | 1-26 | 1-27 | 1-28 | 1-29 | 1-30 |
| pigment | | Percent (percent by | 21 | 21 | 21 | 21 | 21 |
| | | mass) | | | | | |
| Polymerizable | Monofunctional | Phenoxyethyl | | 20 | | 20 | 15 |
| compound | compound | acrylate | | | | | |
| | | Acryloylmorpholine | 20 | 20 | 30 | 20 | 15 |
| | | Isobornyl acrylate | 10 | 10 | 10 | 10 | 5 |
| | | Benzyl acrylate | | | 20 | | |
| | | Tetrahydro furfuryl | 20 | 5 | | 3 | 5 |
| | | acrylate | | | | | |
| | | Hydroxybutyl | 4 | | | | |
| | | acrylate | | | | | |
| | | ME-4S | 2 | | 3 | | 5 |
| | | V#150D | 5 | | | | 5 |
| | | FA-512AS | 5 | | 3 | | |
| | Polyfunctional | 1,9-Nonane diol | | 5 | | 3 | 4 |
| | compound | diacrylate | | | | | |
| | | TMPTA | 2 | 5 | | 3 | 5 |
| | | KAYARAD R-684 | | | | 2 | 2 |
| | | KAYARAD DPCA- | 2 | 2 | | 2 | 2 |
| | | 60 | | | | | |

| | | | | | | |
|---|---|---|---|---|---|---|
| Oligomer | UV-3010 | | 2 | | | |
| | CN963J85 | | | 2 | 2 | 2 |
| Surfactant | BYK-3575 | 0.3 | 0.3 | 0.3 | 0.3 | 0.3 |
| | WET270 | | | | | |
| Polymerization initiator | Darocure TPO | 7 | 8 | 9 | | |
| | Irgacure 819 | | | | | |
| | BMS | | | | | |
| | PBZ | | | | 7 | 7 |
| | Speedcure DETX | 2 | 2 | 2 | | |
| Hydrogen donor | KAYACURE PEA | | | | 7 | 7 |
| Polymerization inhibitor | 4-methoxyphenol | 0.2 | 0.2 | 0.2 | 0.2 | 0.2 |

| | | | | | |
|---|---|---|---|---|---|
| Total (Percent by mass) | 100 | 100 | 100 | 100 | 100 |

TABLE 7

| | | | Example | | | | |
|---|---|---|---|---|---|---|---|
| | | | 2-31 | 2-32 | 2-33 | 2-34 | 2-35 |
| Liquid dispersion of white | | Type | 1-31 | 1-32 | 1-33 | 1-34 | 1-35 |
| pigment | | Percent (percent by | 21 | 21 | 21 | 21 | 21 |
| | | mass) | | | | | |
| Polymerizable | Monofunctional | Phenoxyethyl | 20 | 10 | 20 | | 20 |
| compound | compound | acrylate | | | | | |
| | | Acryloylmorpholine | 20 | 20 | 20 | 20 | 20 |
| | | Isobornyl acrylate | 10 | 10 | 10 | 20 | 10 |
| | | Benzyl acrylate | | 10 | | 5 | |
| | | Tetrahydro furfuryl | 5 | 5 | 5 | | 5 |
| | | acrylate | | | | | |
| | | Hydroxybutyl | | 5 | | 4 | |
| | | acrylate | | | | | |
| | | ME-4S | | | | 5 | |
| | | V#150D | | | | 5 | |
| | | FA-512AS | | | | | |
| | Polyfunctional | 1,9-Nonane diol | 5 | | 5 | 2 | |
| | compound | diacrylate | | | | | |
| | | TMPTA | 5 | 5 | 5 | | 2 |
| | | KAYARAD R-684 | 2 | 2 | 2 | 2 | 2 |
| | | KAYARAD DPCA- | 2 | 2 | | | 2 |
| | | 60 | | | | | |
| Oligomer | | UV-3010 | | | | | 2 |
| | | CN963J85 | | | 2 | 2 | 2 |
| Surfactant | | BYK-3575 | | | | | |
| | | WET270 | 0.3 | 0.3 | 0.3 | 0.3 | 0.3 |
| Polymerization initiator | | Darocure TPO | 5 | 5 | 5 | | |
| | | Irgacure 819 | 3 | 3 | 3 | | |
| | | BMS | | | | 7 | 7 |
| | | PBZ | | | | | |
| | | Speedcure DETX | 2 | 2 | 2 | | |
| Hydrogen donor | | KAYACURE PEA | | | | 7 | 7 |
| Polymerization inhibitor | | 4-methoxyphenol | 0.2 | 0.2 | 0.2 | 0.2 | 0.2 |
| Total (Percent by mass) | | | 100 | 100 | 100 | 100 | 100 |
| | | | Example | | | | |
| | | | 2-36 | 2-37 | 2-38 | 2-39 | 2-40 |
| Liquid dispersion of white | | Type | 1-36 | 1-37 | 1-38 | 1-39 | 1-40 |
| pigment | | Percent (percent by | 21 | 21 | 21 | 21 | 21 |
| | | mass) | | | | | |
| Polymerizable | Monofunctional | Phenoxyethyl | | 20 | | 20 | 15 |
| compound | compound | acrylate | | | | | |
| | | Acryloylmorpholine | 20 | 20 | 30 | 20 | 15 |
| | | Isobornyl acrylate | 10 | 10 | 10 | 10 | 5 |
| | | Benzyl acrylate | | | 20 | | |
| | | Tetrahydro furfuryl | 20 | 5 | | 3 | 5 |
| | | acrylate | | | | | |
| | | Hydroxybutyl | 4 | | | | |
| | | acrylate | | | | | |
| | | ME-4S | 2 | | 3 | | 5 |
| | | V#150D | 5 | | | | 5 |
| | | FA-512AS | 5 | | 3 | | |
| | Polyfunctional | 1,9-Nonane diol | | 5 | | 3 | 4 |
| | compound | diacrylate | | | | | |
| | | TMPTA | 2 | 5 | | 3 | 5 |
| | | KAYARAD R-684 | | | | 2 | 2 |
| | | KAYARAD DPCA- | 2 | 2 | | 2 | 2 |
| | | 60 | | | | | |

| | | | | | | |
|---|---|---|---|---|---|---|
| Oligomer | UV-3010 | | 2 | | | |
| | CN963J85 | | | 2 | 2 | 2 |
| Surfactant | BYK-3575 | 0.3 | 0.3 | 0.3 | 0.3 | 0.3 |
| | WET270 | | | | | |
| Polymerization initiator | Darocure TPO | 7 | 8 | 9 | | |
| | Irgacure 819 | | | | | |
| | BMS | | | | | |
| | PBZ | | | | 7 | 7 |
| | Speedcure DETX | 2 | 2 | 2 | | |
| Hydrogen donor | KAYACURE PEA | | | | 7 | 7 |
| Polymerization inhibitor | 4-methoxyphenol | 0.2 | 0.2 | 0.2 | 0.2 | 0.2 |

| | | | | | |
|---|---|---|---|---|---|
| Total (Percent by mass) | 100 | 100 | 100 | 100 | 100 |

TABLE 8

| | | | Example | | | | |
|---|---|---|---|---|---|---|---|
| | | | 2-41 | 2-42 | 2-43 | 2-44 | 2-45 |
| Liquid dispersion of white | | Type | 1-41 | 1-42 | 1-43 | 1-44 | 1-45 |
| pigment | | Percent (percent by | 21 | 21 | 21 | 21 | 21 |
| | | mass) | | | | | |
| Polymerizable | Monofunctional | Phenoxyethyl | 20 | 10 | 20 | | 20 |
| compound | compound | acrylate | | | | | |
| | | Acryloylmorpholine | 20 | 20 | 20 | 20 | 20 |
| | | Isobornyl acrylate | 10 | 10 | 10 | 20 | 10 |
| | | Benzyl acrylate | | 10 | | 5 | |
| | | Tetrahydro furfuryl | 5 | 5 | 5 | | 5 |
| | | acrylate | | | | | |
| | | Hydroxybutyl | | 5 | | 4 | |
| | | acrylate | | | | | |
| | | ME-4S | | | | 5 | |
| | | V#150D | | | | 5 | |
| | | FA-512AS | | | | | |
| | Polyfunctional | 1,9-Nonane diol | 5 | | 5 | 2 | |
| | compound | diacrylate | | | | | |
| | | TMPTA | 5 | 5 | 5 | | 2 |
| | | KAYARAD R-684 | 2 | 2 | 2 | 2 | 2 |
| | | KAYARAD DPCA- | 2 | 2 | | | 2 |
| | | 60 | | | | | |
| Oligomer | | UV-3010 | | | | | 2 |
| | | CN963J85 | | | 2 | 2 | 2 |
| Surfactant | | BYK-3575 | | | | | |
| | | WET270 | 0.3 | 0.3 | 0.3 | 0.3 | 0.3 |
| Polymerization initiator | | Darocure TPO | 5 | 5 | 5 | | |
| | | Irgacure 819 | 3 | 3 | 3 | | |
| | | BMS | | | | 7 | 7 |
| | | PBZ | | | | | |
| | | Speedcure DETX | 2 | 2 | 2 | | |
| Hydrogen donor | | KAYACURE PEA | | | | 7 | 7 |
| Polymerization inhibitor | | 4-Methoxyphenol | 0.2 | 0.2 | 0.2 | 0.2 | 0.2 |
| Total (Percent by mass) | | | 100 | 100 | 100 | 100 | 100 |
| | | | Example | | | | |
| | | | 2-46 | 2-47 | 2-48 | 2-49 | 2-50 |
| Liquid dispersion of white | | Type | 1-46 | 1-47 | 1-48 | 1-49 | 1-50 |
| pigment | | Percent (percent by | 21 | 21 | 21 | 21 | 21 |
| | | mass) | | | | | |
| Polymerizable | Monofunctional | Phenoxyethyl | | 20 | | 20 | 15 |
| compound | compound | acrylate | | | | | |
| | | Acryloylmorpholine | 20 | 20 | 30 | 20 | 15 |
| | | Isobornyl acrylate | 10 | 10 | 10 | 10 | 5 |
| | | Benzyl acrylate | | | 20 | | |
| | | Tetrahydro furfuryl | 20 | 5 | | 3 | 5 |
| | | acrylate | | | | | |
| | | Hydroxybutyl | 4 | | | | |
| | | acrylate | | | | | |
| | | ME-4S | 2 | | 3 | | 5 |
| | | V#150D | 5 | | | | 5 |
| | | FA-512AS | 5 | | 3 | | |
| | Polyfunctional | 1,9-Nonane diol | | 5 | | 3 | 4 |
| | compound | diacrylate | | | | | |
| | | TMPTA | 2 | 5 | | 3 | 5 |
| | | KAYARAD R-684 | | | | 2 | 2 |
| | | KAYARAD DPCA- | 2 | 2 | | 2 | 2 |
| | | 60 | | | | | |

| | | | | | | |
|---|---|---|---|---|---|---|
| Oligomer | UV-3010 | | 2 | | | |
| | CN963J85 | | | 2 | 2 | 2 |
| Surfactant | BYK-3575 | 0.3 | 0.3 | 0.3 | 0.3 | 0.3 |
| | WET270 | | | | | |
| Polymerization initiator | Darocure TPO | 7 | 8 | 9 | | |
| | Irgacure 819 | | | | | |
| | BMS | | | | | |
| | PBZ | | | | 7 | 7 |
| | Speedcure DETX | 2 | 2 | 2 | | |
| Hydrogen donor | KAYACURE PEA | | | | 7 | 7 |
| Polymerization inhibitor | 4-Methoxyphenol | 0.2 | 0.2 | 0.2 | 0.2 | 0.2 |

| | | | | | |
|---|---|---|---|---|---|
| Total (Percent by mass) | 100 | 100 | 100 | 100 | 100 |

TABLE 9

| | | | Comparative Example | | | | |
|---|---|---|---|---|---|---|---|
| | | | 2-1 | 2-2 | 2-3 | 2-4 | 2-5 |
| Liquid dispersion of white | | Type | 1-1 | 1-1 | 1-2 | 1-2 | 1-3 |
| pigment | | Percent (percent by | 21 | 21 | 21 | 21 | 21 |
| | | mass) | | | | | |
| Polymerizable | Monofunctional | Phenoxyethyl | 20 | 10 | 20 | | 20 |
| compound | compound | acrylate | | | | | |
| | | Acryloylmorpholine | 20 | 20 | 20 | 20 | 20 |
| | | Isobornyl acrylate | 10 | 10 | 10 | 20 | 10 |
| | | Benzyl acrylate | | 10 | | 5 | |
| | | Tetrahydro furfuryl | 5 | 5 | 5 | | 5 |
| | | acrylate | | | | | |
| | | Hydroxybutyl | | 5 | | 4 | |
| | | acrylate | | | | | |
| | | ME-4S | | | | 5 | |
| | | V#150D | | | | 5 | |
| | | FA-512AS | | | | | |
| | Polyfunctional | 1,9-Nonane diol | 5 | | 5 | 2 | |
| | compound | diacrylate | | | | | |
| | | TMPTA | 5 | 5 | 5 | | 2 |
| | | KAYARAD R-684 | 2 | 2 | 2 | 2 | 2 |
| | | KAYARAD DPCA- | 2 | 2 | | | 2 |
| | | 60 | | | | | |
| Oligomer | | UV-3010 | | | | | 2 |
| | | CN963J85 | | | 2 | 2 | 2 |
| Surfactant | | BYK-3575 | | | | | |
| | | WET270 | 0.3 | 0.3 | 0.3 | 0.3 | 0.3 |
| Polymerization initiator | | Darocure TPO | 5 | 5 | 5 | | |
| | | Irgacure 819 | 3 | 3 | 3 | | |
| | | BMS | | | | 7 | 7 |
| | | PBZ | | | | | |
| | | Speedcure DETX | 2 | 2 | 2 | | |
| Hydrogen donor | | KAYACURE PEA | | | | 7 | 7 |
| Polymerization inhibitor | | 4-Methoxyphenol | 0.2 | 0.2 | 0.2 | 0.2 | 0.2 |
| Total (Percent by mass) | | | 100 | 100 | 100 | 100 | 100 |
| | | | Comparative Example | | | | |
| | | | 2-6 | 2-7 | 2-8 | 2-9 | 2-10 |
| Liquid dispersion of white | | Type | 1-3 | 1-4 | 1-4 | 1-5 | 1-6 |
| pigment | | Percent (percent by | 21 | 21 | 21 | 21 | 21 |
| | | mass) | | | | | |
| Polymerizable | Monofunctional | Phenoxyethyl | | 20 | | 20 | 15 |
| compound | compound | acrylate | | | | | |
| | | Acryloylmorpholine | 20 | 20 | 30 | 20 | 15 |
| | | Isobornyl acrylate | 10 | 10 | 10 | 10 | 5 |
| | | Benzyl acrylate | | | 20 | | |
| | | Tetrahydro furfuryl | 20 | 5 | | 3 | 5 |
| | | acrylate | | | | | |
| | | Hydroxybutyl | 4 | | | | |
| | | acrylate | | | | | |
| | | ME-4S | 2 | | 3 | | 5 |
| | | V#150D | 5 | | | | 5 |
| | | FA-512AS | 5 | | 3 | | |
| | Polyfunctional | 1,9-Nonane diol | | 5 | | 3 | 4 |
| | compound | diacrylate | | | | | |
| | | TMPTA | 2 | 5 | | 3 | 5 |
| | | KAYARAD R-684 | | | | 2 | 2 |
| | | KAYARAD DPCA- | 2 | 2 | | 2 | 2 |
| | | 60 | | | | | |

| | | | | | | |
|---|---|---|---|---|---|---|
| Oligomer | UV-3010 | | 2 | | | |
| | CN963J85 | | | 2 | 2 | 2 |
| Surfactant | BYK-3575 | 0.3 | 0.3 | 0.3 | 0.3 | 0.3 |
| | WET270 | | | | | |
| Polymerization initiator | Darocure TPO | 7 | 8 | 9 | | |
| | Irgacure 819 | | | | | |
| | BMS | | | | | |
| | PBZ | | | | 7 | 7 |
| | Speedcure DETX | 2 | 2 | 2 | | |
| Hydrogen donor | KAYACURE PEA | | | | 7 | 7 |
| Polymerization inhibitor | 4-Methoxyphenol | 0.2 | 0.2 | 0.2 | 0.2 | 0.2 |

| | | | | | |
|---|---|---|---|---|---|
| Total (Percent by mass) | 100 | 100 | 100 | 100 | 100 |

In Tables 4 to 9, the product names and the manufacturing companies of the ingredients are as follows:

Monofunctional Compound

Isobornyl acrylate (IBXA, SP value of 7.24, manufactured by OSAKA ORGANIC CHEMICAL INDUSTRY LTD.)

Benzyl acrylate (VISCOAT® #160, SP value of 10.00, manufactured by OSAKA ORGANIC CHEMICAL INDUSTRY LTD.)

Tetrahydrofurfuryl acrylate: (VISCOAT® #150, SP value of 9.97, manufactured by OSAKA ORGANIC CHEMICAL INDUSTRY LTD.)

Compound represented by the following Chemical structure (1) (V #150D, Sp value of 11.58, manufactured by OSAKA ORGANIC CHEMICAL INDUSTRY LTD.)

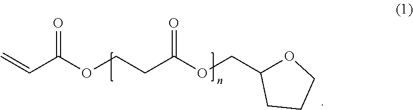

In Chemical structure (1), n represents an integer of 1 or above.

Polyfunctional Compound

1,9-Nonane diol diacrylate (VISCOAT® #260, bifunctional monomer, SP value of 9.08, manufactured by OSAKA ORGANIC CHEMICAL INDUSTRY LTD.)

Trimethylol propane triacrylate (TMPTA in Table, VISCOAT® #295, trifunctional monomer, SP value of 8.54, manufactured by OSAKA ORGANIC CHEMICAL INDUSTRY LTD.)

Tricyclodecan dimethanol diacrylate (KAYARAD R-684, bifunctional monomer, SP value of 8.10, manufactured by Nippon Kayaku Co., Ltd.)

ε-caprolactone-modified dipentaelythritol (KAYARAD DPCA-60, polyfunctional monomer 5 or more functional monomer, SP value of 8.85, manufactured by Nippon Kayaku Co., Ltd.)

Oligomer

Urethane acrylate resin (UV-3010B, UV curing resin, manufactured by The Nippon Synthetic Chemical Industry Co., Ltd.)

Aliphatic urethane acrylate (IBOA blend): (CN963J85, bifuncitonal monomer, manufactured by Sartomer Company)

Surfactant

Surfactant (BYK-3575, manufactured by BYK Japan KK.)

Surfactant (WET270, manufactured by Evonik Industries AG) Polymerization Initiator

Polymerization initiator (DAROCURE TPO, manufactured by BASF)

Polymerization initiator (Irgacure 819: manufactured by BASF)

Polymerization initiator (BMS in Table, 4-Benzoyl-4′-methyldiphenylsulfide, manufactured by Tokyo Chemical Industry Co. Ltd.)

Polymerization initiator (PBZ in Table, 4-Phenylbenzophene, manufactured by Tokyo Chemical Industry Co. Ltd.)

Polymerization initiator (SpeedcureDETX, manufactured by Lambson Group Ltd.) Hydrogen Donor
4-Dimethylamino ethylbenzoate (KAYACYRE EPA, manufactured by Nippon Kayaku Co., Ltd.)

Polymerization Inhibitor

4-Methoxyphenol (manufactured by Nippon Kayaku Co., Ltd.)

The curable compositions of Examples 2-1 to 2-50 and Comparative Examples 2-1 to 2-10 were evaluated on white concealing property, discharging stability, liquid permeability, discharging stability, storage stability (viscosity change ratio), curability (cumulative irradiance required for curing), and attachability in the following manner.

The results are shown in Tables 10 and 15.

White Concealing Property

A printer (SG7100, manufactured by Ricoh Co., Ltd.) remodeled for evaluation was filled with the curable composition and printed a 10 cm×10 cm solid image on a recording medium (COSMOSHINE® A4300 coat PET film, average thickness of 100 μm, transparent, manufactured by TOYOBO CO., LTD.).

The obtained solid image was cured with a UV-LED device (UV-LED module, single pass water cooling, manufactured by USHIO INC.) for inkjet printers in such a condition that the irradiance was 1 W/cm² and the cumulative irradiance was 500 mJ/cm² so that a 10 cm×10 cm image (cured matter) having an average thickness of 10 μm was obtained.

The cumulative irradiance was measured with an ultraviolet intensity meter (UM-10) and a light receptor (UM-400) (both manufactured by KONICA MINOLTA, INC.). The average thickness can be measured with an electronic micrometer (manufactured by ANRITSU CORPORATION) by averaging thicknesses at 10 points of the image.

The white concealing property was evaluated with a printer (SG7100, manufactured by Ricoh Co., Ltd.) incorporating an MH2620 head (manufactured by Ricoh Co., Ltd.) capable of discharging thickened ink while heating.

Black paper (Extra Black, density of 1.65, manufactured by TAKEO Co., Ltd.) was placed on the side of the recording medium opposite to the image side. The image density against black was measured using a reflection spectrometer (X-Rite 939, manufactured by X-Rite Inc.). The concealing ratio was calculated according to the following formula (1) to evaluate concealing property.

The concealing property becomes good as the concealing ratio increases.

Concealing ratio(percent)=[1−(density of image)/density(1.65)of black paper]×100

Evaluation Criteria

A: 80 percent or more
B: 70 percent to less than 80 percent
C: 60 percent to less than 70 percent
D: Less than 60 percent

Liquid Permeability

Each curable composition at 100 mL was filtered with a hydrophobic PTFE membrane filter with an average pore size of 10.0 μm under a pressure at 50 kPa to evaluate the liquid permeability according to the following evaluation criteria.

Evaluation Criteria

A: 75 mL or greater passed through
B: 50 to less than 75 mL passed through
C: 25 to less than 50 mL passed through
D: Less than 25 mL passed through

Discharging Stability

An inkjet printer having a piezo inkjet head capable of controlling the temperatures from the ink supply system to the head portion was filled with each of the obtained curable components. After the temperatures were controlled to achieve a viscosity of 10 mPa·s, the inkjet printer continuously discharged the curable composition at 3 kHz for 60 minutes to evaluate the discharging stability according to the following evaluation criteria.

Temperatures at which an ink viscosity of from 0.95 to 1.05 mPa·S was achieved were checked using a cone plate type viscometer capable of controlling temperatures and determined as the heating condition at the time of printing.

Evaluation Criteria

A: Properly discharged from nozzles at 95 percent or more
B: Properly discharged from nozzles at from 90 to less than 95 percent
C: Properly discharged from nozzles at from 70 to less than 90 percent
D: Properly discharged from nozzles at less than 70 percent

Storage Stability

Immediately after each of the curable compositions was prepared, the initial viscosity thereof was measured using a cone plate type rotatory viscometer (VISCOMETER TV-22, manufactured by TOKI SANGYO CO., LTD.) under such conditions that the temperature of the hemathermal cycling water was 25 degrees C., the rate of rotation was 50 rpm, and the shearing speed was 191.4 sec⁻¹.

Thereafter, each curable composition was left to rest at 70 degrees C. for 14 days and the viscosity thereof was measured in the same manner as for the initial viscosity.

The viscosity change ratio was calculated from the following formula (5). The storage stability was evaluated on a basis of the viscosity change ratio according to the following evaluation criteria. The storage stability becomes excellent as the viscosity change ratio decreases.

Viscosity change ratio(percent)={(viscosity after stored at 70 degrees C. for 14 days)−(initial viscosity)]/(initial viscosity)}×100 (5)

Evaluation Criteria

A: Viscosity change ratio is 5 percent or less
B: Viscosity change ratio is from more than 5 percent to 15 percent
C: Viscosity change ratio is from more than 15 percent to 30 percent
D: Viscosity change ratio is greater than 30 percent

Curability

A printer (SG7100, manufactured by Ricoh Co., Ltd.) remodeled for evaluation was filled with the curable composition and printed a 10 cm×10 cm solid image on a recording medium (COSMOSHINE® A4300 coat PET film, average thickness of 100 μm, transparent, manufactured by TOYOBO CO., LTD.).

The printed solid image was subjected to curing treatment under an irradiance of 1 W/cm² using a UV-LED (UV-LED module, single pass water cooling, manufactured by USHIO INC.) for inkjet printing so that a 10 cm×10 cm image (cured product) having a thickness of 10 μm was obtained.

The image was determined as cured if the image was free of feel of tackiness when touched by a finger. The cumulative irradiance (J/cm²) required for curing was calculated.

The image was evaluated on curability on a basis of the cumulative irradiance required for curing according to the following evaluation criteria.

A cumulative irradiance required for curing of 2.0 J/cm² or less was determined as suitable for practical purpose.

The cumulative irradiance was measured with an ultraviolet intensity meter (UM-10) and a light receptor (UM-400) (both manufactured by KONICA MINOLTA, INC.)

The average thickness can be measured with an electronic micrometer (manufactured by ANRITSU CORPORATION) by averaging thicknesses at 10 points of the image.

The curability was evaluated with a printer (SG7100) incorporating an MH2620 head (manufactured by Ricoh Co., Ltd.) capable of discharging thickened ink while heating.

Evaluation Criteria

A: 1.0 J/cm² or less
B: more than 1.0 to 1.5 J/cm²
C: more than 1.5 to 2.0 mJ/cm²
D: More than 2.0 J/cm²

Attachability

A 10 cm×10 cm image (cured matter) having an average thickness of 10 μm was obtained using each of the curable composition.

The solid portion of the obtained image was cut with a cutter to 100 square cells each with a length of 1 mm according to JIS K5400 format followed by peeling off with a scotch tape (Scotch mending tap (18 mm), manufactured by 3M). The number of cells not peeled off was counted while checking them with a loupe (PEAK No. 1961 (×10), manufactured by Tohkai Sangyo Co., Ltd.) and evaluated on attachability according to the following evaluation criteria.

Evaluation Criteria

A: Cell not peeled off was 100 out of 100
B: Cell not peeled off was from 80 to 99 out of 100
C: Cell not peeled off was from 40 to 79 out of 100
D: Cell not peeled off was 39 or less out of 100

TABLE 10

| | Example | | | | | | | | | |
|---|---|---|---|---|---|---|---|---|---|---|
| | 2-1 | 2-2 | 2-3 | 2-4 | 2-5 | 2-6 | 2-7 | 2-8 | 2-9 | 2-10 |
| Viscosity change ratio | 3 | 4 | 3 | 2 | 5 | 2 | 8 | 6 | 7 | 8 |
| (percent) | | | | | | | | | | |
| Cumulative irradiance | 0.3 | 0.5 | 0.4 | 0.4 | 0.4 | 0.3 | 0.6 | 0.4 | 0.5 | 0.9 |
| required for curing (J/cm²) | | | | | | | | | | |
| White concealing property | A | A | A | A | A | A | A | A | A | A |
| Liquid permeability | A | A | A | A | A | A | A | A | A | A |
| Discharging stability | A | A | A | A | A | B | A | B | A | A |
| Attachability | A | A | A | A | A | A | A | A | A | A |

TABLE 11

| | Example | | | | | | | | | |
|---|---|---|---|---|---|---|---|---|---|---|
| | 2-11 | 2-12 | 2-13 | 2-14 | 2-15 | 2-16 | 2-17 | 2-18 | 2-19 | 2-20 |
| Viscosity change ratio | 3 | 4 | 3 | 2 | 5 | 2 | 8 | 6 | 7 | 8 |
| (percent) | | | | | | | | | | |
| Cumulative irradiance | 0.9 | 0.8 | 0.4 | 0.5 | 0.8 | 0.8 | 0.9 | 0.9 | 1.1 | 1.0 |
| required for curing (J/cm²) | | | | | | | | | | |
| White concealing property | A | A | A | A | A | A | A | A | A | A |
| Liquid permeability | A | A | A | A | A | A | A | A | A | A |
| Discharging stability | A | A | B | B | A | B | A | A | A | B |
| Attachability | A | A | A | A | A | A | A | B | A | A |

TABLE 12

| | Example | | | | | | | | | |
|---|---|---|---|---|---|---|---|---|---|---|
| | 2-21 | 2-22 | 2-23 | 2-24 | 2-25 | 2-26 | 2-27 | 2-28 | 2-29 | 2-30 |
| Viscosity change ratio | 3 | 4 | 3 | 2 | 5 | 2 | 8 | 6 | 7 | 8 |
| (percent) | | | | | | | | | | |
| Cumulative irradiance | 0.5 | 0.4 | 0.5 | 0.6 | 0.5 | 0.4 | 0.6 | 0.9 | 0.5 | 0.6 |
| required for curing (J/cm²) | | | | | | | | | | |
| White concealing property | A | A | A | A | A | A | A | A | A | A |
| Liquid permeability | B | A | B | A | B | A | A | A | B | B |
| Discharging stability | A | B | A | A | A | B | B | B | A | B |
| Attachability | A | A | A | B | A | A | A | B | A | A |

TABLE 13

| | Example | | | | | | | | | |
|---|---|---|---|---|---|---|---|---|---|---|
| | 2-31 | 2-32 | 2-33 | 2-34 | 2-35 | 2-36 | 2-37 | 2-38 | 2-39 | 2-40 |
| Viscosity change ratio | 3 | 4 | 3 | 2 | 5 | 2 | 8 | 6 | 7 | 8 |
| (percent) | | | | | | | | | | |
| Cumulative irradiance | 1.1 | 0.9 | 1.0 | 1.2 | 1.3 | 1.2 | 1.1 | 1.6 | 1.8 | 1.4 |
| required for curing (J/cm²) | | | | | | | | | | |
| White concealing property | A | A | A | A | A | A | A | A | A | A |
| Liquid permeability | A | A | B | A | A | A | A | A | A | A |
| Discharging stability | A | A | A | A | A | B | A | B | A | B |
| Attachability | B | B | A | B | B | B | B | A | B | A |

TABLE 14

| | Example | | | | | | | | | |
|---|---|---|---|---|---|---|---|---|---|---|
| | 2-41 | 2-42 | 2-43 | 2-44 | 2-45 | 2-46 | 2-47 | 2-48 | 2-49 | 2-50 |
| Viscosity change ratio | 12 | 16 | 19 | 14 | 15 | 22 | 23 | 15 | 20 | 19 |
| (percent) | | | | | | | | | | |
| Cumulative irradiance | 1.0 | 1.0 | 1.1 | 1.5 | 1.2 | 1.6 | 1.7 | 1.6 | 1.8 | 1.3 |
| required for curing (J/cm²) | | | | | | | | | | |
| White concealing property | B | B | B | B | B | B | B | B | B | B |
| Liquid permeability | B | A | B | A | B | A | A | A | B | A |
| Discharging stability | B | B | A | B | A | B | B | B | A | B |
| Attachability | B | B | A | B | B | B | B | A | B | A |

TABLE 15

| | Comparative Example | | | | | | | | | |
|---|---|---|---|---|---|---|---|---|---|---|
| | 2-1 | 2-2 | 2-3 | 2-4 | 2-5 | 2-6 | 2-7 | 2-8 | 2-9 | 2-10 |
| Viscosity change ratio | 210 | 225 | 46 | 91 | 187 | 78 | 453 | 480 | 884 | 543 |
| (percent) | | | | | | | | | | |
| Cumulative irradiance | 1.1 | 1.2 | 1.4 | 2.4 | 2.7 | 1.2 | 1.4 | 1.8 | 2.2 | 2.1 |
| required for curing (J/cm²) | | | | | | | | | | |
| White concealing property | B | B | C | B | C | C | D | D | C | C |
| Liquid permeability | D | D | D | D | D | C | D | D | D | D |
| Discharging stability | C | D | D | C | D | D | C | D | C | D |
| Attachability | D | D | D | D | D | D | D | D | D | D |

As seen in the results shown in Tables 10 to 15, the curable compositions of Examples 2-1 to 2-50 are good on white concealing property, liquid permeability, discharging storage stability, storage stability, curability, and attachability in comparison with Comparative Examples 2-1 to 2-10.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. A pigment dispersion composition comprising:
one or more pigments selected from the group consisting of strontium titanate, calcium titanate, and zinc sulfide;
a pigment dispersant having an amine value of from 10 to 100 mgKOH/g; and
a polymerizable compound.

2. The pigment dispersion composition according to claim 1, wherein the pigment dispersant comprises a dispersant polymer comprising at least one member selected from the group consisting of a copolymer having a basic functional group, an acrylic block copolymer, and a copolymer having an alkylol ammonium salt and an acid radical.

3. The pigment dispersion composition according to claim 1, wherein the polymerizable compound comprises a polymerizable compound having a solubility parameter (SP value) of 9.00 or greater.

4. The pigment dispersion composition according to claim 3, wherein the polymerizable compound having an SP value of 9.00 or greater comprises at least one member selected from the group consisting of phenoxyethyl acrylate, acryloylmorpholine, 4-hydroxybutyl acrylate, tetrahydro furfuryl acrylate, methoxy tetraethylene glycol acrylate, dicyclopentanyl oxyethyl acrylate, and a compound represented by the following Chemical Formula (1): 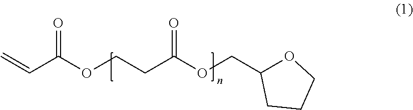
where n represents an integer of 1 or above.

5. The pigment dispersion composition according to claim 1, wherein the one or more pigments have a number average primary particle diameter of from 100 to 300 nm.

6. The pigment dispersion composition according to claim 1, wherein a proportion of the pigment dispersant to the one or more pigments is from 10.0 to 70.0 percent by mass.

7. The pigment dispersion composition according to claim 1, wherein the pigment dispersion composition is free of an organic solvent.

8. A curable composition comprising:
one or more pigments selected from the group consisting of strontium titanate, calcium titanate, and zinc sulfide;
a pigment dispersant having an amine value of from 10 to 100 mgKOH/g;
a polymerizable compound; and
a polymerization initiator.

9. A method of forming two or three dimensional images, comprising:
inkjetting the curable composition of claim 8.

10. An accommodating container comprising:
a container containing the curable composition of claim 8.

11. A device for forming two or three dimensional images, comprising:
an accommodating unit containing the curable composition of claim 8;
an applying device configured to apply the curable composition contained in the accommodating unit; and
a curing device configured to cure the curable composition that has been applied.

12. A method of forming two or three dimensional images, comprising:
applying the curable composition of claim 8; and
curing the curable composition.

13. Cured matter derived from the curable composition of claim 8.

14. A decoration comprising:
a substrate; and
a decorative portion on the substrate, comprising the cured matter of claim 13.
